(19) United States
(12) Patent Application Publication
(10) Pub. No.: US 2026/0343632 A1
(43) Pub. Date: Oct. 29, 2026

(54) Security Key Generation for Wireless Communication Systems

(71) Applicant: QUALCOMM Incorporated, San Diego, CA (US)

(72) Inventors: Karthika PALADUGU, Hyderabad (IN); Soo Bum Lee, San Diego, CA (US); Karl Georg Hampel, Jersey City, NJ (US); Gavin Bernard Horn, La Jolla, CA (US)

(21) Appl. No.: 19/187,034

(22) Filed: Apr. 23, 2025

(51) Int. Cl. H04W 76/10; H04W 12/041

(52) U.S. Cl. CPC H04W 76/10; H04W 12/041

(57) ABSTRACT

Disclosed are techniques for wireless communications within a communication system. In one aspect, a method includes, at a user equipment (UE) establishing a first radio resource control (RRC) connection between the UE and a first network node. The method further includes receiving, from the first network node, a message comprising key generation information. The key generation being configured to generate a security key corresponding to a second network node which is neighboring the first network node. The method further includes generating the security key corresponding to the second network node based at least in part on the key generation information and an anchor key shared between the UE and a core network.

### BACKGROUND

### 1. Field of the Disclosure

The present disclosure generally relates to wireless communications. In particular, the aspects of the present disclosure relate to security key generation for wireless communication systems.

### 2. Description of Related Art

Wireless communications systems are deployed to provide various telecommunications and data services, including telephony, video, data, messaging, and broadcasts. Broadband wireless communications systems have developed through various generations, including a first-generation analog wireless phone service (1G), a second-generation (2G) digital wireless phone service (including interim 2.5G networks), a third-generation (3G) high speed data, Internet-capable wireless device, and a fourth-generation (4G) service (e.g., Long-Term Evolution (LTE), WiMax. Examples of wireless communications systems include code division multiple access (CDMA) systems, time division multiple access (TDMA) systems, frequency division multiple access (FDMA) systems, orthogonal frequency division multiple access (OFDMA) systems, Global System for Mobile communication (GSM) systems, etc. Other wireless communications technologies include 802.11 Wi-Fi, Bluetooth, among others.

A fifth-generation (5G) mobile standard calls for higher data transfer speeds, greater number of connections, and better coverage, among other improvements. The 5G standard (also referred to as “New Radio” or “NR”), according to Next Generation Mobile Networks Alliance, is designed to provide data rates of several tens of megabits per second to each of tens of thousands of users. Several hundreds of thousands of simultaneous connections should be supported in order to support large sensor deployments. A sixth-generation (6G) mobile standard may build on 5G to offer further increased data transfer speeds, better coverage, and enhanced security, among other improvements.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are methods, apparatuses (e.g., user equipment (UE), network nodes), and computer-readable media for performing wireless communications.

In one illustrative example, a UE for wireless communication is provided. The UE comprises one or more memories and one or more processors coupled to the one or more memories. The one or more processors are individually or collectively configured to cause the UE to establish a first radio resource control (RRC) connection between the UE and a first network node. The one or more processors further cause the UE to receive, from the first network node, a message comprising key generation information configured to generate a security key corresponding to a second network node neighboring the first network node. The one or more processors further cause the UE to generate the security key corresponding to the second network node based at least in part on the key generation information and an anchor key shared between the UE and a core network.

In another example, a method for wireless communication is provided. The method is implemented at a UE and comprises establishing a first RRC connection between the UE and a first network node. The method further comprises receiving, from the first network node, a message comprising key generation information configured to generate a security key corresponding to a second network node neighboring the first network node. The method further comprises generating the security key corresponding to the second network node based at least in part on the key generation information and an anchor key shared between the UE and a core network.

In another example, a first network node for wireless communication is provided. The first network node comprises one or more memories and one or more processors coupled to the one or more memories. The one or more processors are individually or collectively configured to cause the first network node to establish a first RRC connection between the first network node and a UE and identify a second network node configured to serve the UE. The second network node is neighboring the first network node. The one or more processors further cause the first network node to receive key generation information for the second network node in response to identifying the second network node configured to serve the UE. The one or more processors further cause the first network node to transmit a message comprising the received key generation information to the UE.

In another example, a method for wireless communication is provided. The method is implemented at a first network node and comprises establishing a first RRC connection between the first network node and a UE. The method further comprises identifying a second network node configured to serve the UE. The second network node is neighboring the first network node. The method further comprises receiving key generation information for the second network node in response to identifying the second network node configured to serve the UE and transmitting a message comprising the received key generation information to the UE.

In another example, a non-transitory computer-readable medium is provided having stored thereon instructions that, when executed by one or more processors, cause a UE to establish a first RRC connection between the UE and a first network node. The instructions further cause the UE to receive, from the first network node, a message comprising key generation information configured to generate a security key corresponding to a second network node neighboring the first network node. The instructions further cause the UE to generate the security key corresponding to the second network node based at least in part on the key generation information and an anchor key shared between the UE and a core network.

In another example, a non-transitory computer-readable medium is provided having stored thereon instructions that, when executed by one or more processors, cause a first network node to establish a first RRC connection between the first network node and a UE and identify a second network node configured to serve the UE. The second network node is neighboring the first network node. The instructions further cause the first network node to receive key generation information for the second network node in response to identifying the second network node configured to serve the UE. The instructions further cause the first network node to transmit a message comprising the received key generation information to the UE.

In another example, a UE for wireless communication is provided. The UE comprises means for establishing a first RRC connection between the UE and a first network node. The UE further comprises means for receiving, from the first network node, a message comprising key generation information configured to generate a security key corresponding to a second network node neighboring the first network node. The UE further comprises means generating the security key corresponding to the second network node based at least in part on the key generation information and an anchor key shared between the UE and a core network.

In another example, a first network node for wireless communication is provided. The first network node comprises means for establishing a first RRC connection between the first network node and a UE. The UE further comprises means for identifying a second network node configured to serve the UE. The second network node is neighboring the first network node. The first network node further comprises means for receiving key generation information for the second network node in response to identifying the second network node configured to serve the UE. The first network node further comprises means for transmitting a message comprising the received key generation information to the UE.

Aspects generally include a method, apparatus, system, computer program product, non-transitory computer-readable medium, user equipment, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, and systems having different shapes, sizes, and/or packaging arrangements. For example, some aspects may be implemented via integrated chip or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). In some aspects, one or more of the apparatuses described herein can include, can be, or can be part of a mobile device (e.g., a mobile telephone or so-called “smart phone”, a tablet computer, or other type of mobile device), a network-connected wearable device, an extended reality device (e.g., a virtual reality (VR) device, an augmented reality (AR) device, or a mixed reality (MR) device), a personal computer, a laptop computer, a server computer (e.g., a video server or other server device), a television, a vehicle (or a computing device or system of a vehicle), a camera (e.g., a digital camera, an Internet Protocol (IP) camera, etc.), a multi-camera system, a robotics device or system, an aviation device or system, or other device. It is intended that aspects described herein may be practiced in a wide variety of devices, components, systems, distributed arrangements, and/or end-user devices of varying size, shape, and constitution.

Other advantages associated with the aspects disclosed herein will be apparent to those skilled in the art based on the accompanying drawings and detailed description.

### BRIEF DESCRIPTION OF THE DRAWINGS

Examples of various implementations are described in detail below with reference to the following figures:

FIG. 1 shows a block diagram illustrating an example of a wireless communication system, in accordance with some examples;

FIG. 2 shows a design of a base station or network node and a user equipment (UE) that enable transmission and processing of signals exchanged between the UE and the network node, in accordance with some examples;

FIG. 3 shows a diagram illustrating an example of a disaggregated base station, in accordance with some examples;

FIG. 4 shows a diagram illustrating a high level architecture of an exemplary communication system, in accordance with some aspects of the present disclosure;

FIG. 5 shows a high level call flow diagram illustrating techniques for generating security keys for wireless communication systems, in accordance with some aspects of the present disclosure;

FIG. 6 shows another high level call flow diagram illustrating techniques for generating security keys for wireless communication systems, in accordance with some aspects of the present disclosure;

FIG. 7 shows another high level call flow diagram illustrating techniques for generating security keys for wireless communication systems, in accordance with some aspects of the present disclosure;

FIG. 8 shows yet another high level call flow diagram illustrating techniques for generating security keys for wireless communication systems, in accordance with some aspects of the present disclosure;

FIG. 9 shows a block diagram of a device that supports generating security keys for wireless communication systems, in accordance with some aspects of the present disclosure;

FIG. 10 shows another block diagram of a device that supports generating security keys for wireless communication systems, in accordance with some aspects of the present disclosure;

FIG. 11 shows a diagram of a system including a device that supports generating security keys for wireless communication systems, in accordance with some aspects of the present disclosure;

FIG. 12 shows a block diagram of a device that supports generating security keys for wireless communication systems, in accordance with some aspects of the present disclosure;

FIG. 13 shows another block diagram of a device that supports generating security keys for wireless communication systems, in accordance with some aspects of the present disclosure;

FIG. 14 shows a diagram of a system including a device that supports generating security keys for wireless communication systems, in accordance with some aspects of the present disclosure;

FIG. 15 shows a flowchart illustrating a method that supports generating security keys for wireless communication systems, in accordance with some aspects of the present disclosure; and

FIG. 16 shows a flowchart illustrating another method that supports generating security keys for wireless communication systems, in accordance with some aspects of the present disclosure.

### DETAILED DESCRIPTION

In certain wireless communication systems, a user equipment (UE) may interact with multiple network nodes such as in dual connectivity or handover scenarios, but not limited thereto. In such scenarios, a primary network node (MN) is primarily responsible for deriving security keys used for secondary network nodes (SN). Thus, the MN has full knowledge of the security keys of the SN. Moreover, the security keys of the SN are directly dependent on a security key of the MN. Thus, any compromise with the security key of the MN inherently affects both MN-UE and SN-UE communications. In case of handover, a subsequent handover of a UE requires the UE to receive a radio resource control (RRC) Reconfiguration with Sync message to ensure separation of security keys. However, this process introduces latency/delays, impacting seamless mobility. Thus, the existing approaches of key management presents challenges related to delays during mobility and potential security vulnerabilities in communications between the UE and the network nodes.

In some examples, the present disclosure discloses techniques for independently generating unique security keys for different network nodes based on key generation information and an anchor key shared between the UE and a core network. The security keys may be generated in such a manner that a security key and key generation information corresponding to a network node are unique to the network node and independent of other network nodes. In such solution, the security key of the network node may be known mainly to the network node and remaining network nodes may be unaware of the security node of the network node. In some examples, the generation of the security key of the network node may be independent of the security keys of other network nodes of the wireless communication systems. In such examples, by minimizing the key dependency among network nodes, the techniques of the present disclosure may enhance security and minimize risks associated with key compromises. Additionally, the techniques of the present disclosure may reduce delays that may be observed sometimes (e.g., during mobility transitions). Thus, the techniques of the present disclosure may contribute to improvements in the efficiency and security of UE-to-network communications.

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the scope of the application as set forth in the appended claims.

It shall be noted that for convenience of explanation, the present disclosure may include terms and names defined in one or more standard organizations, such as the 3rd generation partnership project (3GPP) standard organization, the open radio access network (O-RAN) Alliance standard organization, and the like. Such terms as well as the associated features and operations are to be interpreted as consistent with those specified in one or more technical specifications.

In the present disclosure, the terms like “wireless network”, “wireless communication system”, and “communication system” have been used interchangeably throughout the disclosure. The terms like “network node” and “base station” have been used interchangeably throughout the disclosure.

As noted above, techniques are described herein for generating security keys for wireless communication systems. In one aspect, a UE establishes a first RRC connection between the UE and a first network node. The UE receives a message from the first network node. The message comprises key generation information configured to generate a security key corresponding to a second network node. The second network node is neighboring the first network node. The UE generates the security key corresponding to the second network node based at least in part on the key generation information and an anchor key shared between the UE and a core network.

In another aspect of the present disclosure, a first network node establishes a first RRC connection between the first network node and a UE. The first network node identifies a second network node configured to serve the UE. The second network node is neighboring the first network node. The first network node receives key generation information for the second network node in response to identifying the second network node. The first network node transmits a message comprising the received key generation information to the UE.

Additional aspects of the present disclosure are described in more detail below.

Wireless communication systems are deployed to provide various communication services, such as voice, video, packet data, messaging, broadcast, and the like. A wireless communication system may support both access links for communication between wireless devices. An access link may refer to any communication link between a client device (e.g., a user equipment (UE), a station (STA), or other client device) and a base station (e.g., a 3^{rd} Generation Partnership Project (3GPP) gNodeB (gNB) for 5G/NR, a 3GPP eNodeB (eNB) for LTE, a Wi-Fi access point (AP), or other base station) or a component of a disaggregated base station (e.g., a central unit, a distributed unit, and/or a radio unit). In one example, an access link between a UE and a 3GPP gNB may be over a Uu interface. In some cases, an access link may support uplink signaling, downlink signaling, connection procedures, etc.

As used herein, the terms “user equipment” (UE) and “network node” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs may communicate with a core network via a RAN, and through the core network the UEs may be coupled with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A “network node” or “network entity” may be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which the base station is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems, the base station may provide additional control and/or network management functions. A communication link through which UEs may send signals to a base station is called an uplink (UL) channel (e.g., a reverse traffic channel, a reverse control channel, an access channel, etc.). A communication link through which the base station may send signals to UEs is called a downlink (DL) or forward link channel (e.g., a paging channel, a control channel, a broadcast channel, or a forward traffic channel, etc.). The term traffic channel (TCH), as used herein, may refer to either an uplink, reverse or downlink, and/or a forward traffic channel.

The term “network node” or “base station” (e.g., with an aggregated/monolithic base station architecture or disaggregated base station architecture) may refer to a single physical transmit receive point (TRP) or to multiple physical TRPs that may or may not be co-located. For example, where the term “network node” or “base station” refers to a single physical TRP, the physical TRP may be an antenna of the base station corresponding to a cell (or several cell sectors) of the base station. Where the term “network node” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas coupled to a common source via a transport medium) or a remote radio head (RRH) (a remote base station coupled to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network node or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

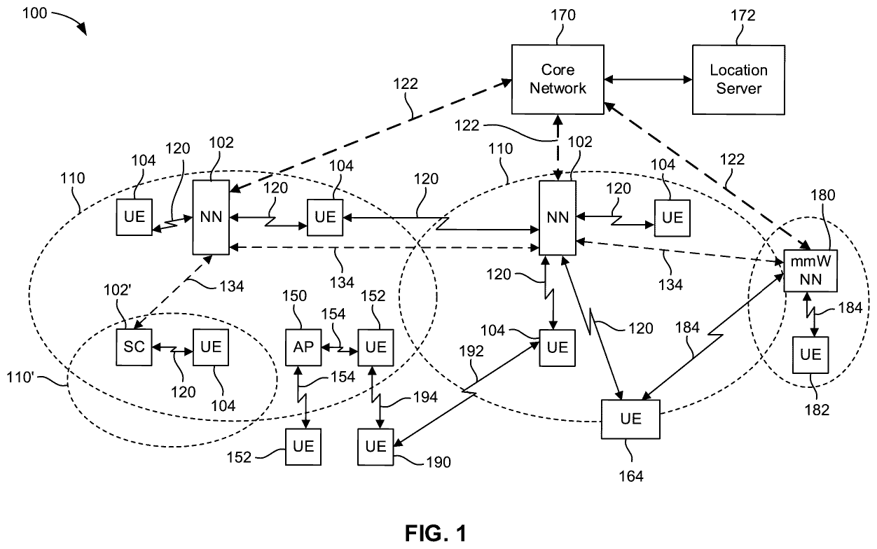

Various aspects of the systems and techniques described herein will be discussed below with respect to the figures. According to various aspects, FIG. 1 illustrates an example of a wireless communication system 100. The wireless communication system 100 (which may also be referred to as a wireless wide area network (WWAN)) may include various base stations 102 and various UEs 104. In some aspects, the base stations 102 may also be referred to as “network entities” or “network nodes.” One or more of the base stations 102 may be implemented in an aggregated or monolithic base station architecture. Additionally, or alternatively, one or more of the base stations 102 may be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 may include macro cell base stations (high power cellular base stations) and/or small cell base stations (low power cellular base stations). In an aspect, the macro cell base station may include eNBs and/or ng-eNBs where the wireless communication system 100 corresponds to a long term evolution (LTE) network, or gNBs where the wireless communication system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is the physical transmission point of a cell, the terms “cell” and “TRP” may be used interchangeably. In some cases, the term “cell” may also refer to a geographic coverage area of a base station (e.g., a sector), insofar as a carrier frequency may be detected and used for communication within some portion of geographic coverage areas 110.

While geographic coverage areas 110 of neighboring macro cell base station 102 may partially overlap (e.g., in a handover region), some of the geographic coverage areas 110 may be substantially overlapped by a larger geographic coverage area 110. For example, a small cell (SC) base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communication system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communication system 100 may include devices (e.g., UEs, etc.) that communicate with one or more UEs 104, base stations 102, APs 150, etc., utilizing the ultra-wideband (UWB) spectrum. The UWB spectrum may range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communication system 100 may further include a millimeter wave (mmW) network node or base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in said band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain signaling information and signals, for example, those that are UE-specific may not be present in the secondary carrier, since both primary uplink and downlink carriers are UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like may be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (e.g., 40 MHz), compared to that attained by a single 20 MHz carrier.

In order to operate on multiple carrier frequencies, a base station 102 and/or a UE 104 may be equipped with multiple receivers and/or transmitters. For example, a UE 104 may have two receivers, “Receiver 1” and “Receiver 2,” where “Receiver 1” is a multi-band receiver that may be tuned to band (e.g., carrier frequency) ‘X’ or band ‘Y,’ and “Receiver 2” is a one-band receiver tunable to band ‘Z’ only. In said example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2 ,” the UE 104 may measure band ‘Z’ without interrupting the service on band ‘X’ or band ‘Y.’

The wireless communication system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communication system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 coupled to one of the base stations 102 (e.g., through which UE 190 may indirectly obtain cellular connectivity) and a D2D P2P link 194 with WLAN STA 152 coupled to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

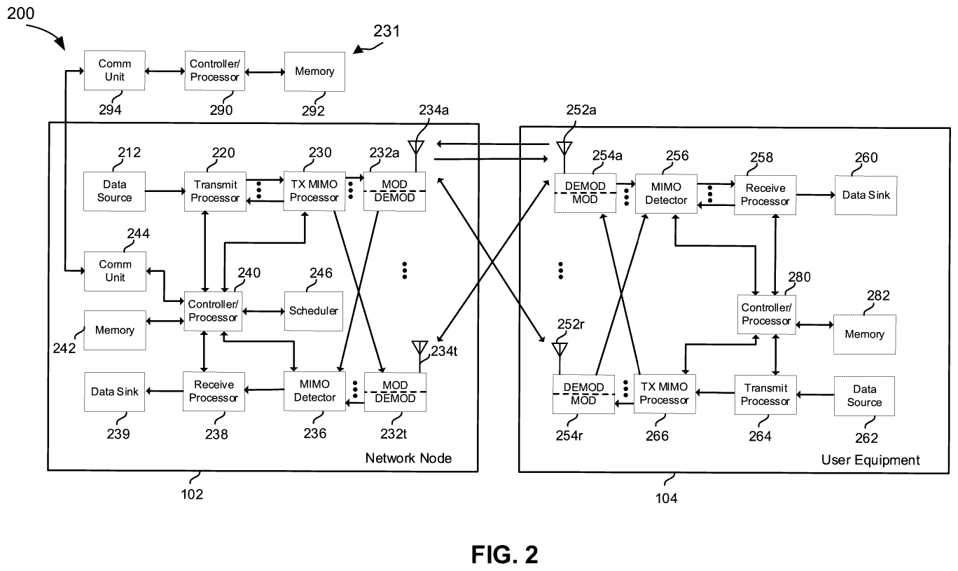

FIG. 2 shows a block diagram of a design of a base station or network node 102 and a UE 104 that enable transmission and processing of signals exchanged between the UE and the base station, in accordance with some aspects of the present disclosure. Design 200 includes components of a base station 102 and a UE 104, which may be one of the base stations 102 and one of the UEs 104 in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators may be separate components. Each modulator of the modulators 232a to 232t may process a respective output symbol stream, e.g., for an orthogonal frequency-division multiplexing (OFDM) scheme and/or the like, to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals may be generated with location encoding to convey additional information.

At UE 104, antennas 252a through 252r may receive the downlink signals from base station 102 and/or other base stations and may provide received signals to demodulators (DEMODs) 254a through 254r, respectively. The demodulators 254a through 254r are shown as a combined modulator-demodulator (MOD-DEMOD). In some cases, the modulators and demodulators may be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based at least in part on a beta value or a set of beta values associated with the one or more reference signals). The symbols from transmit processor 264 may be precoded by a TX-MIMO processor 266 if application, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 if applicable, and further processed by a receive processor 238 to obtain decoded data and control information sent by UE 104. Receive processor 238 may provide the decoded data to a data sink 239 and the decoded control information to controller (processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with security key generation for wireless communication systems.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also may be implemented as virtual units, e.g., a virtual central unit (vCU), a virtual distributed unit (vDU), or a virtual radio unit (vRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

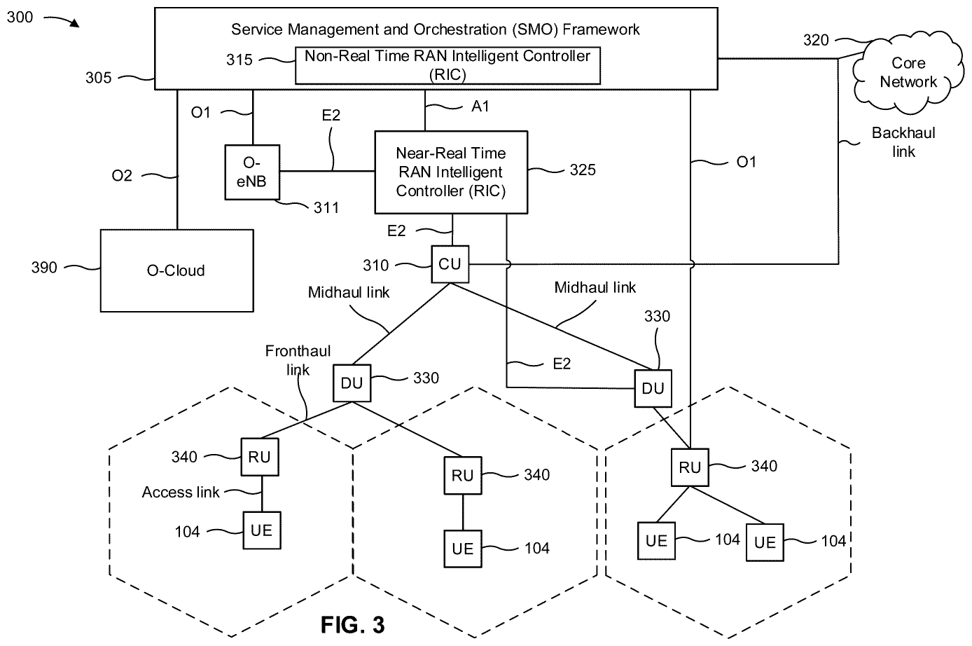

FIG. 3 shows a diagram illustrating an example architecture of a disaggregated base station 300. The disaggregated base station 300 may include one or more central units (CUs) 310 that may communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective mid-haul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units, e.g., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 may be logically split into one or more CU-UP units and one or more CU-CP units. The CU-UP unit may communicate bidirectionally with the CU-CP unit via an interface, such as the E1 interface when implemented in an O-RAN configuration. The CU 310 may be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) may be implemented with an interface configured to communicate signals with other layers (and modules) hosted by the DU 330, or with the control functions hosted by the CU 310.

Lower-layer functionality may be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 may be implemented to handle over the air (OTA) communication with one or more UEs 104. In some implementations, real-time and non-real-time aspects of control and user plane communication with the RU(s) 340 may be controlled by the corresponding DU 330. In some scenarios, such configuration may enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements may include, but are not limited to, CUs 310, DUs 330, RUs 340 and Near-RT RICs 325. In some implementations, the SMO Framework 305 may communicate with a hardware aspect of a 4G RAN, such as an open eNB (O-eNB) 311, via an O1 interface. Additionally, in some implementations, the SMO Framework 305 may communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

Various systems and techniques are provided with respect to wireless technologies (e.g., the 3GPP 5G/New Radio (NR) Standard, 6G, etc.) to provide improvements to wireless communications. A UE 104 may be configured to access a wireless network (e.g., the wireless communication system 100) to communicate with other devices. As a part of accessing the wireless network, the UE 104 may be configured to authenticate with the wireless network. Based on the authentication, the UE 104 may establish one or more security contexts to allow for private communications between the UE 104 and services of the wireless network. In some wireless networks, a UE 104 connecting to the wireless network may establish a security context with a security function of the core network 170 (e.g., non-access stratum (NAS) security). Based on the security context, additional application layer security may be established on top of the security context.

In some cases, access stratum (AS) security may be used to secure a connection between a UE 104 and a network node 102 of the wireless network that is coupled to the UE 104. The network node 102 may be a base station (or a part of a disaggregated base station), such as a gNB, eNB, CU, DU, etc., through which access to a wireless network may be provided. The AS security may apply a layer of security to a radio interface that connects the UE 104 to the network node 102 of the wireless network. The AS security may be anchored at the network node 102 and the AS security may be based on a cryptographic key of the network node 102, such as an AS root key. In some cases, such as for a disaggregated base station, AS security may be anchored at a CU and AS security may be based on a cryptographic key of the CU, such as an AS root key or CU key.

A MAC layer may be a protocol layer which manages radio resources for communications between network nodes 102 and UEs 104 in some wireless networks. For example, the MAC layer may serve to map between logical channels and transport channels, determine resource allocations, such as time/frequence resources, transmission scheduling, and the like. In some cases, such as for a disaggregated base station, the MAC layer may be hosted by DUs associated with a CU. The MAC layer may use MAC messages (e.g., in MAC protocol data units (PDU)) to signal various information between a UE 104 and a network node 102 to manage radio resources. The MAC PDU may be a message format for MAC message (e.g., messages of the MAC layer). In some cases, the MAC PDUs may not be protected from potential attacks, making them vulnerable to attacks which could degrade and/or disrupt a connection between the UE 104 and the network node 102. In some cases, the AS root key may also be used to provide security for the MAC messages.

Systems, apparatuses, processes (also referred to as methods), and computer-readable media (collectively referred to as “systems and techniques”) are described herein for communicating with wireless communication systems securely or for securing messages/data (e.g., MAC messages) communicated (e.g., transmitted and/or received) between a UE 104 and network nodes 102.

In an aspect, when a UE 104 is powered ON, the UE 104 may initiate an initial attach process or connection setup procedure to establish a connection with the wireless network. The initial attach process comprises several key operations, as discussed briefly in the forthcoming paragraph.

The UE 104 may scan for nearby cells and acquire synchronization signals (PSS and SSS) to identify a suitable cell and synchronize with cell timing. After synchronization (uplink and downlink synchronization), the UE 104 may initiate an RRC connection establishment process to establish radio resources needed for communication with the wireless network. Once the RRC connection is established, the UE 104 may send a Registration Request message to the Core Network 170 (or to an Access and Mobility Management Function of the core network 170) to register with the wireless network. The Registration Request message may include identity information of the UE 104, security credentials of the UE 104, capability information of the UE 104, etc. A mutual authentication process may then take place where both the UE 104 and the wireless network verify each other's identity e.g., using authentication and key agreement (AKA) procedure. To secure communications between the wireless network and the UE 104, the UE 104 and the wireless network perform security setup to establish security keys. Once the security setup is complete, an access and mobility management function (AMF) of the core network (e.g., the core network 170 of FIG. 1) completes the registration process. After successful registration, the wireless network sends an RRC Reconfiguration message to the UE 104 including configuration information for data transmission. The UE 104 may then establish PDU sessions to set up data paths to send/receive data.

In some cases, as a part of the AKA procedure during the initial connection setup, the AMF may generate a security key (e.g., a cryptographic key) of the network node 102, such as an AS root key (denoted as “K_{NG-RAN}” or “K_{gNB}”) to secure communications between the UE 104 and the network node 102. In some cases, the security key K_{gNB} may be derived from another key of the core network. Once the security key K_{gNB} is available, the network node 102 may generate additional keys from the security key K_{gNB} for services provided by the network node 102, such as an RRC encryption key K_{RRCenc}, RRC integrity protection key K_{RRCint}, UP encryption key K_{UPenc}, UP integrity protection key K_{UPint}, and the like. The security key K_{gNB} may be unique to the network node 102 and cannot be reused across different network nodes. To achieve key synchronization with the UE 104, the network node 102 may communicate one or more parameters to the UE 104. Based on the received parameters, the UE 104 may locally generate a security key of the network node 102. In another example, the network node 102 may transmit the generated security key K_{gNB} to the UE 104. The transmission of the security key K_{gNB} to the UE 104 may occur within a securely protected message so that the security key K_{gNB} cannot be intercepted or tampered with by malicious entities.

Once both the UE 104 and the network node 102 possess the security key of the network node, the UE 104 and the network node 102 may use the security key to communicate (transmit and/or receive) messages, secured using the security key, between the UE 104 and the network node 102. For example, the network node 102 may encrypt downlink messages (e.g., using the security key) before transmitting them to the UE 104 and the UE 104 may decrypt the received messages. Similarly, the UE 104 may encrypt uplink messages (e.g., using the security key), and the network node 102 may decrypt the uplink messages upon receipt. This way messages are communicated securely through an air interface between the UE 104 and the network node 102 with the help of the security key(s).

In some cases, the network node 102 may need to derive additional security keys from the security key (K_{gNB}) of the network node 102. This is particularly relevant in cases where the UE 104 interacts with multiple network nodes 102 such as dual connectivity, handover, carrier aggregation, but not limited thereto. Consider an example of a dual-connectivity setup, where the UE 104 is simultaneously connected to two network nodes 102, where one of the two network nodes 102 may function as a master network node or a primary network node (MN) and the other network node may function as a secondary network node or slave network node (SN). The MN and SN may operate on different frequency bands and may use different RATs. Some example dual connectivity deployment scenarios may include NR-NR dual connectivity (NR-DC), new generation-radio access network (NG-RAN) E-UTRA dual connectivity (NGEN-DC), NE dual connectivity, and E-UTRA-NR dual connectivity (EN-DC). As an example, for NR-DC, one of the two network nodes 102 may be a master network node using NR technology and another network node may be a secondary network node also using the NR technology.

In the dual connectivity setup (e.g., in NR-DC), when the UE 104 first attaches to the wireless network, the UE 104 may connect to the MN, where the AKA procedure may be performed. The core network 170 may generate and provide a security key (named as “a master security key”, denoted as K_{MN}) to the MN for securing data communicated between the MN and the UE 104. However, since the UE 104 is simultaneously connecting to the SN to improve throughput, the UE 104 needs to have a unique secondary security key (denoted as K_{SN}) corresponding to the SN. The secondary security key K_{SN} is used for securing data communicated between the SN and the UE 104. In the existing NR-DC setups, the secondary security key K_{SN} is derived by the MN. Specifically, the MN derives the secondary security key K_{SN} based on the master security key. Thus, the secondary security key K_{SN} is dependent on the master security key K_{MN}.

The current approach of key management in dual connectivity setups presents challenges related to communication security. For example, the MN is responsible for deriving the secondary security key K_{SN}. In other words, the MN has full knowledge of the secondary security key K_{SN}. Thus, the MN can easily monitor, modify, or even decrypt communications between the UE 104 and the SN. If security of the MN is compromised e.g., due to a cyberattack, an attacker may exploit MN's knowledge of the secondary security key K_{SN} to manipulate SN-UE communication. Therefore, since the secondary security key K_{SN} is directly dependent on the master security key K_{MN}, any compromise of the master security key K_{MN} may automatically impact both MN-UE and SN-UE communications. Further, mobility of the UE 104 in the dual connectivity setup may lead to change of the MN and/or the SN. For example, the UE 104 may move to a new cell where a new MN is responsible for primary connectivity. Thus, both security keys (K_{MN} and K_{SN}) need to be updated (even if there is no change in the SN) since the new MN derives new master and/or secondary security keys (K_{MN′} and K_{SN′}) for the new MN and the existing SN. Such process introduces additional signaling overhead, delay during UE mobility, and reset of protocol stack. Similar challenges exist in handover related scenarios, as discussed in forthcoming paragraphs.

Mobility support is provided in the wireless network, where a UE 104 may travel from one coverage area or cell to another coverage area or cell. For example, a source network node (or a serving network node) may serve the UE 104 in a coverage area of the source network node. The UE 104 may continuously monitor signal strength, interference, and other radio conditions and may report channel measurements to the source network node. When the source network node detects a degradation in channel quality based on the reported channel measurements and/or other channel information, the source network node may select a target or candidate network node for handover of the UE 104 e.g., based on the RSRP, RSRQ, SINR, load on the source network node, resource availability of the source network node, etc. Once the target network node is identified, the source network node initiates handover procedures.

When the handover procedure is initiated, the source network node may generate a security key for the target network node before the UE 104 completes the handover so that the UE 104 does not need to wait for key derivation after the handover and can immediately resume communication with the target network node. The source network node may generate the security key for the target network node from an existing security key of the source network node. Similar to the dual connectivity, since the security key for the target network node is directly dependent on the security key of the source network node, any compromise of the security key of the source network node may automatically impact communications between UE and the target network node. Further, a subsequent handover of the UE 104 requires the UE 104 to receive an RRC Reconfiguration with Sync message (e.g., with a new next hop parameter chaining counter (NCC)) to ensure separation of security keys. However, such process introduces latency/delays, impacting seamless mobility.

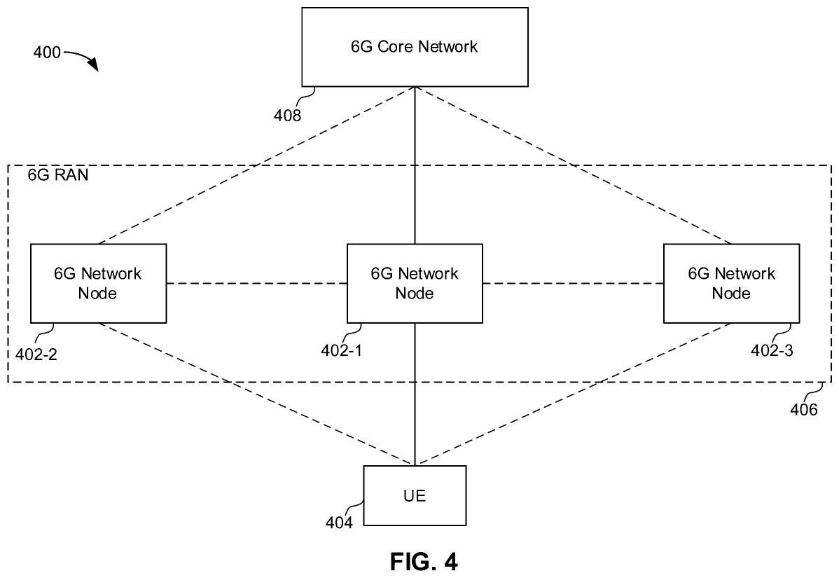

These challenges introduce security risks, increase latency, and affect overall performance of the communication system 100. Unlike 5G dual connectivity, there may not be any dependency of network nodes in 6G dual connectivity setups. Each network node may be independently configured to serve the UE 104 and may be directly connected to the same core network (e.g., as shown in FIG. 4) thereby removing the need for a Master-Secondary security key dependency.

FIG. 4 shows a high-level architecture of an exemplary wireless communication system 400, in accordance with some aspects of the present disclosure. The communication system 400 may be based on 6G RAT and may comprise a plurality of network nodes 402-1, 402-2, 402-3 (also denoted as “402”) wirelessly serving a UE 404. Though one UE 404 is shown in FIG. 4 for simplicity, there may be a plurality of UEs served by the plurality of network nodes 402. Each of the plurality of network nodes 402 may be a “6G network node” and may be named as a “6G base station” or “6G RAN node” or “base station”. The plurality of network nodes 402 may collectively form a 6G RAN 406. In one example, the plurality of network nodes 402 may include a first network node 402-1 and at least one neighboring network node to the first network node 402-1. The at least one neighboring network node may include a second network node 402-2 and at least one third network node 402-3. The plurality of network nodes 402 may interface with a common core network 408 (e.g., a 6G core network or 6GC) through backhaul links. The core network 408 may manage authentication and key distribution for the plurality of network nodes 402 and provide secure connectivity without hierarchical dependencies, thereby eliminating the need for the Master-Secondary security key dependency.

The UE 404 may be substantially similar to the UE 104 of FIG. 1-3. The first network node 402-1 may comprise a first base station implemented in an aggregated RAN architecture or implemented in a disaggregated RAN architecture. The second network node 402-2 may comprise a second base station implemented in an aggregated RAN architecture or implemented in a disaggregated RAN architecture. In some cases, when the first and second base stations are implemented in a disaggregated RAN architecture, each of the first and second base stations may include a CU communicatively coupled with one or more DUs. In some cases, the first and second base stations are 6G base stations.

In some cases, multiple cell groups may be used to distinguish amongst the different network nodes 402. For example, a first cell group may be a grouping of one or more cells associated with a network node 402 configured for 6G communications. A second cell group may include a grouping of one or more cells associated with another network node 402 configured for 6G communications. The first cell group and the second cell group may interface with the common core network (6GC) 408. The UE 404 may distinguish between the first cell group and the second cell group based on key generation information, and the UE 404 may be configured to communicate with at least one of the first cell group and the second cell group. From the perspective of the UE 404, if a particular cell group is provisioned with distinct key generation information, the UE 404 may interpret the particular cell group as belonging to a different network node. As a result, the UE 404 may generate separate security key(s) for communication with the different network node via the associated particular cell group. Thus, cell groups may be adapted to allow the UE 404 to distinguish between multiple network nodes to allow for separate security keys for the multiple network nodes.

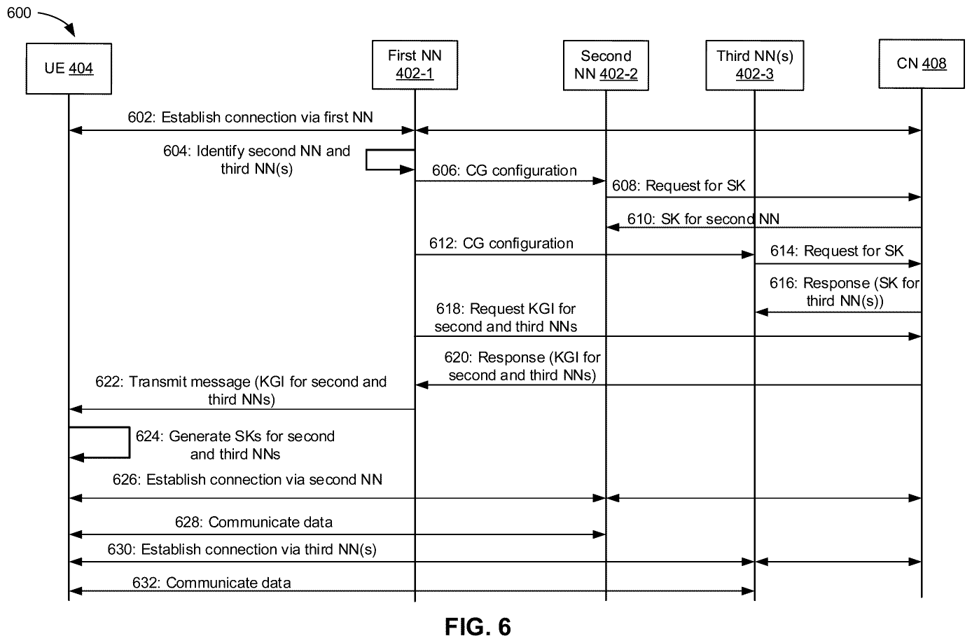

In one example, the first network node 402-1 may associate itself with the first cell group and configure the first cell group as a serving cell group for the UE 404. The first network node 402-1 may identify neighboring network nodes (e.g., the second network node 402-2) and may associate the second network node 402-2 with the second cell group. The second cell group may be configured as a target cell group for establishing dual-connectivity or for performing handover of the UE 404. Since the first and second network nodes are hierarchically independent in the communication system shown in FIG. 6, the first cell group and the second cell group are also hierarchically independent from each other and are associated with the same core network 408.

Consider an example of a dual connectivity setup in the communication system 400, where the UE 404 is served by the first network node 402-1 or by the first cell group associated with the first network node 402-1. As a part of the AKA procedure during the initial connection setup, the core network 408 may generate and provide a first security key K_{6G-RAN1} to the first network node 402-1 for securing data communicated between the first network node 402-1 and the UE 404. Consider that the first network node 402-1 identifies a second network node 402-2 as a target network node for dual connectivity. The first network node 402-1 may configure the second cell group associated with the second network node 402-2 as the target cell group for establishing the dual-connectivity. The first network node 402-1 may receive key generation information for the second network node 402-2 and transmit the received key generation information to the UE 404. The first network node 402-1 may receive key generation information either from the core network 408 or from the second network node 402-2. The first network node 402-1 may forward the received key generation to the UE 404. Based on the received key generation information, the UE 404 may generate a second security key K_{6G-RAN2} corresponding to the second network node 402-2 based at least in part on the key generation information and an anchor key shared between the UE 404 and the core network 408. The anchor key is unique to the UE 404.

The UE 404 and the second network node 402-2 may secure the data communicated (e.g., transmitted and/or received) between the UE 404 and the second network node 402-2 using the second security key K_{6G-RAN2}. The key generation information may comprise at least one of a cell group identifier, a network node identifier, a counter, or a random number. It should be noted that the second security key K_{6G-RAN2} and the received key generation information corresponding to the second network node 402-2 are unique to the second network node 402-2 and independent of other network nodes of the communication system 400.

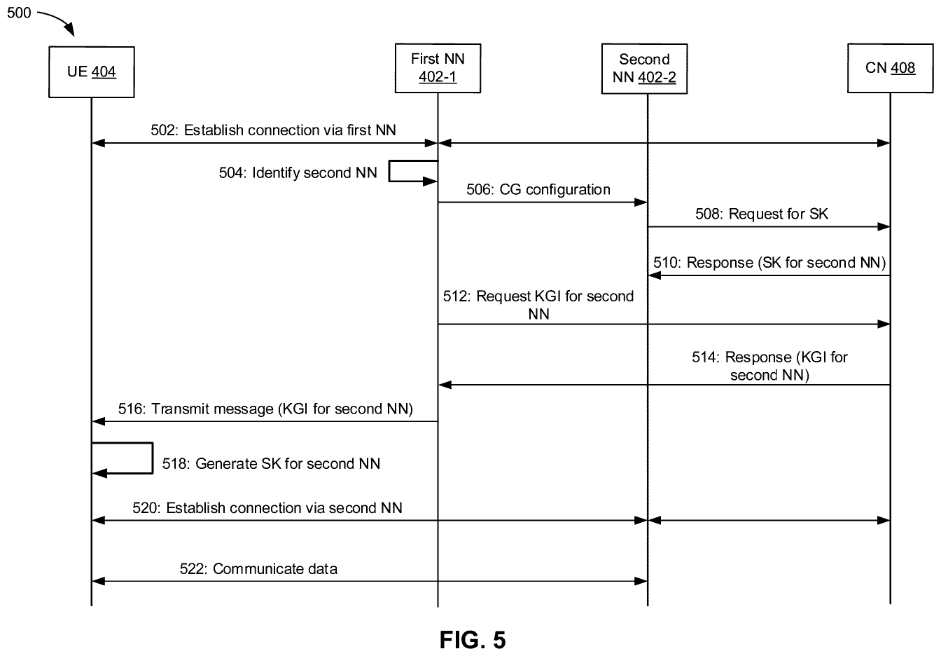

FIG. 5 shows a high-level call flow diagram 500 illustrating techniques for generating security keys for wireless communication systems, in accordance with some aspects of the present disclosure. The call flow diagram 500 illustrated in FIG. 5 includes the UE 404, the first network node (NN) 402-1, the second network node 402-2, and the core network 408 (or a core network node).

At operation 502, when the UE 404 is powered ON, the UE 404 may initiate an initial attach process or connection setup procedure to establish a connection with a wireless network (e.g., the wireless communication system 400) via the first network node 402-1. The initial attach process involves radio resource setup, authentication, security key establishment, and registration with the core network 408. Initially, the UE 404 may scan for nearby cells and acquire synchronization signals (PSS and SSS) to identify a suitable cell and synchronize with cell timing. After synchronization (uplink and downlink synchronization), the UE 404 may initiate an RRC connection establishment process to establish radio resources needed for communication with the wireless network. Once the RRC connection is established, the UE 404 may send a Registration Request message to the core network 408 (or to a core network node such as the AMF of the core network 408) to register with the wireless network. The Registration Request message may include identity information of the UE 404, security credentials of the UE 404, capability information of the UE 404, but not limited thereto. The identity information of the UE 404 may include subscriber permanent identifier (SUPI), subscription concealed identifier (SUCI), or globally unique temporary identifier (GUTI). The security credentials of the UE 404 may include encryption algorithms supported by the UE 404, but not limited thereto. The capability information of the UE 404 may include RATs supported by the UE 404, frequency band in which the UE 404 may operate, network slicing capability, etc.

A mutual authentication process may then take place where both the UE 404 and the wireless network verify each other's identity e.g., using the AKA procedure. To secure communications between the wireless network and the UE 404, the UE 404 and the wireless network perform security setup to establish security keys. As a part of the AKA procedure, the core network 408 (e.g., the AMF) may generate a first AS root key or a first security key K_{6G-RAN1} corresponding to the first network node 402-1. The core network 408 may provide the first security key K_{6G-RAN1} to the first network node 402-1 for securing data communicated between the first network node 402-1 and the UE 404. The first security key K_{6G-RAN1} may be unique to the first network node 402-1 and cannot be reused across different network nodes. The UE 404 and the first network node 402-1 may secure data communicated between the UE 404 and the first network node 402-1 using the first security key K_{6G-RAN1}.

At operation 504, the first network node 402-1 may identify the second network node 402-2 configured to serve the UE 404. The second network node 402-2 may be neighboring the first network node 402-1. The UE 404 may continuously monitor signal strength and signal quality from neighboring network nodes 402 and may send measurement reports to the first network node 402-1 including measurements of RSRP, RSRQ, SINR, etc., of the neighboring network nodes. The first network node 402-1 may identify at least one target network node based on one or more of the measurement reports received from the UE 404, a load associated with the first network node 402-1, mobility information of the UE 404, or capability information of the UE 404. The first network node 402-1 may evaluate own loading conditions and if a current cell of the first network node 402-1 is congested, the first network node 402-1 may decide to offload the UE 404 to neighboring network node(s) for load balancing. The first network node 402-1 may also monitor mobility pattern of the UE 404 (e.g., a direction of movement of the UE 404) for identifying the second network node 402-2. The first network node 402-1 may also evaluate the capability information of the UE 404 to determine whether the UE 404 is capable of dual connectivity and/or carrier aggregation, which frequency bands the UE 404 can operate on, but not limited thereto. Consider that after analyzing the measurement reports, load conditions, mobility information, and/or capability information, the first network node 402-1 identifies the second network node 402-2 as the target network node configured to serve the UE 404 (e.g., suitable for certain features of 6G like Dual Connectivity, Handover, Carrier Aggregation, but not limited thereto). After identifying the second network node 402-2, the first network node 402-1 may configure the second network node 402-2 for serving the UE 404. Specifically, the first network node 402-1 may configure the second cell group associated with the second network node 402-2 as the target cell group.

At operation 506, the first network node 402-1 may communicate with the second network node 402-2 for cell group (CG) configuration/preparation or to configure the second cell group associated with the second network node 402-2 as the target cell group for serving the UE 404. In some examples, as a part of configuring the second cell group, the first network node 402-1 may provide information to the second network node 402-2 about radio resources required for connecting and communicating with the UE 404. After receiving a CG configuration message from the first network node 402-1, the second network node 402-2 may configure and/or allocate specified radio resources for the second cell group to connect and communicate with the UE 404. The second network node 402-2 may also transmit information related to the allocated radio resources to the first network node 402-1 including uplink/downlink scheduling resources, frequency allocation, cell group configuration, and other configuration parameters allocated for communicating with the UE 404.

At operation 508, the second network node 402-2 may transmit a request message to the core network 408 requesting a security key (SK) corresponding to the second network node 402-2. The core network 408 may generate a second security key K_{6G-RAN2} corresponding to the second network node 402-2. The core network 408 may use a predefined Key Derivation Function (KDF) for generating the second security key K_{6G-RAN2}. At operation 510, the core network 408 may transmit a response message including the generated second security key K_{6G-RAN2} to the second network node 402-2. In this manner, the second security key K_{6G-RAN2} is made available at the second network node 402-2, which may be used by the second network node 402-2 for securing data communicated (e.g., transmitted and/or received) between the UE 404 and the second network node 402-2.

At operation 512, after identifying the second network node 402-2, the first network node 402-1 may transmit a request message to the core network 408 (e.g., to the AMF of the core network 408) requesting key generation information for the second network node 402-2. The request message may comprise identity information (e.g., a RAN Global ID) of the second network node 402-2 so that the key generation information is provided for the correct network node. The request may be sent as a next generation application protocol (NGAP) message. In one example, the request may be sent as an AS Security Context Request. In another example, a new NGAP message may be introduced for transmitting the request message to the core network 408.

At operation 514, upon receiving the request, the core network 408 may generate/prepare the key generation information for the second network node 402-2 and sends a response message to the first network node 402-1 including the key generation information. The key generation information may include security material or parameters for deriving a second security key K_{6G-RAN2} corresponding to the second network node 402-2. The security material may include one or more of: a cell group identifier (CGI) which identifies a cell group (e.g., the second cell group) where the second network node 402-2 belongs, a network node identifier (RAN Global ID) which is a unique identifier for the second network node 402-2, a counter (e.g., NCC) to prevent security key reuse, and a random number. In one example, the core network 408 may send the response message as a part of an existing NGAP message (e.g., AS security context response). In another example, a new NGAP message may be introduced for transmitting the response message from the core network 408.

The first network node 402-1 may receive the response message from the core network 408, the response message may comprise the key generation information corresponding to the second network node 402-2. It may be noted that the key generation information of the second network node 402-2 is unique to the second network node 402-2 in the communication system 400. In other words, the key generation information of each network node in the communication system 400 is distinct. Further, the key generation information of the second network node 402-2 is independent of other network nodes of the communication system 400, which means the key generation information of the second network node 402-2 does not depend on any other key generation information of any other network node in the communication system 400.

At operation 516, the first network node 402-1 may transmit a message comprising the key generation information received from the core network 408 to the UE 404 to permit the UE 404 to generate the second security key K_{6G-RAN2} corresponding to the second network node 402-2. The message may be an RRC Reconfiguration message which is used for updating configuration of the UE 404. The message may comprise additional information related to configuration of the second network node 402-2 e.g., the radio resource allocation (including uplink/downlink scheduling resources, frequency allocation), cell group configuration, and other configuration parameters needed for communication with the second network node 402-2. In one example, the core network 408 may cipher the key generation information so that the first network node 402-1 cannot read or modify the key generation information. In such example, the first network node 402-1 simply acts as a relay and forwards the key generation information to the UE 404. Such ciphering ensures that only the UE 404 may extract the key generation information.

The UE 404 may receive, from the first network node 402-1, the message comprising the key generation information configured to generate the second security key K_{6G-RAN2} corresponding to the second network node 402-2. As discussed in connection with operation 510, the message may be an RRC Reconfiguration message and may comprise additional information related to configuration of the second network node 402-2.

At operation 518, the UE 404 may generate a second AS root key or the second security key K_{6G-RAN2} corresponding to the second network node 402-2 based at least in part on the key generation information received from the first network node 402-1. Specifically, the UE 404 may process the received message to extract the key generation information and then may use a predefined KDF for generating the second security key K_{6G-RAN2} based on the received key generation information. In one example, the UE 404 may generate the second security key K_{6G-RAN2} based at least in part on the key generation information and a unique anchor key shared between the UE 404 and the core network 408. The anchor key may be unique to the UE 404.

In one example, the anchor key may be K_{AMF}, which is obtained directly from the core network 408 during the AKA procedure and used for derivation of subsequent security keys. It may be noted that the K_{AMF} is unique for each UE. The key K_{AMF} is a security anchor key for the AMF, which is derived and maintained by the UE 404 and the core network 408. The network nodes 402 of the RAN 406 do not have access to K_{AMF}. The UE 404 may generate the second security key K_{6G-RAN2} as per below expression (1):

K_{6G-RAN2}=KDF(K_{AMF}, KGI) (1)

### Where:

KDF is the predefined Key Derivation Function.
K_{AMF} is the anchor key shared between the UE 404 and the core network 408.
KGI is the key generation information corresponding to the second network node 402-2.

In some cases, the anchor key K_{AMF} is derived from an input key K_{SEAF} (which is a security key for a security anchor function (SEAF)). The input key K_{SEAF} is derived from another input key K_{AUSF} (which is security key for authentication server function (AUSF)). The different key derivations may be performed using one or more key derivation functions defined by relevant 3GPP specification(s). In some cases, the security keys K_{SEAF} or K_{AUSF} may be considered as the anchor key for generation of network node security keys (e.g., for generation of the second security key K_{6G-RAN2}).

Once the UE 404 generates the second security key K_{6G-RAN2} of the second network node 402-2, the UE 404 may send an RRC Reconfiguration Complete message to the first network node 402-1 which may inform the second network node 402-2 of the configuration results for the second network node 402-2. The second network node 402-2 may start communicating with the UE 404 securely using the second security key K_{6G-RAN2}.

At operation 520, the UE 404 may establish a second connection (e.g., an RRC Connection) via the second network node 402-2. In one example, the UE 404 may establish the second RRC connection while maintaining the first RRC connection (e.g., in case of dual connectivity scenario). In case of Handover, the UE 404 may release the first RRC connection and communicate with the second network node 402-2 via the second RRC connection.

At operation 522, the UE 404 may start communicating (e.g., transmitting and/or receiving) data, secured using the second security key K_{6G-RAN2}, between the UE 404 and the second network node 402-2, upon establishing the second RRC connection with the second network node 402-2. Specifically, since the same second security key K_{6G-RAN2} is available at the UE 404 and the second network node 402-2, the UE 404 may encrypt data to be transmitted to the second network node 402-2 (e.g., using the second security key K_{6G-RAN2} generated/available at the UE 404) and then transmit the encrypted data to the second network node 402-2. The second network node 402-2 may decrypt the encrypted data received from the UE 404 (e.g., using the second security key K_{6G-RAN2} which is received from the core network 408 and which is available at the second network node 402-2). Likewise, the second network node 402-2 may encrypt data to be transmitted to the UE 404 (e.g., using the second security key K_{6G-RAN2} received from the core network 408) and then transmit the encrypted data to the UE 404. The UE 404 may decrypt the data received from the second network node 402-2 using the second security key K_{6G-RAN2} generated at the UE 404. In some examples, the UE 404 and the second network node 402-2 may derive additional security keys based on the second security key K_{6G-RAN2} for services provided by the second network node 402-2. The UE 404 and the second network node 402-2 may communicate (e.g., transmit and/or receive) data, secured using the additional security keys, between the UE 404 and the second network node 402-2. For example, the UE 404 and the second network node 402-2 may derive security keys such as K_{RRCenc}, K_{RRCint}, K_{UPenc}, K_{UPint}, and the like.

In one example, the core network 408 may generate the key generation information for the second network node 402-2 after receiving the request for the second security key K_{6G-RAN2} at operation 508. In this example, the core network 408 may generate the second security key K_{6G-RAN2} based at least in part on the key generation information and the unique anchor key which are already available with the core network 408. The core network 408 may use the same predefined KDF for generating the second security key K_{6G-RAN2}, as described in connection with expression (1). It may be noted that the core network 408 generates the second security key K_{6G-RAN2} independent of security keys of the other network node (e.g., independent of the first security key K_{6G-RAN1} corresponding to the first network node 402-1).

It may be noted that the core network 408 may transmit the second security key K_{6G-RAN2} to the second network node 402-2 anytime after operation 508 but before operation 520. However, if the second network node 402-2 does not have the second security key K_{6G-RAN2} when receiving a connection request from the UE 404 at operation 520 (e.g., the second network node 402-2 did not receive the second security key K_{6G-RAN2} from the core network 408), the second network node 402-2 may transmit a request to the core network 408 for the second security key K_{6G-RAN2} and in response the core network 408 may transmit the second security key K_{6G-RAN2} to the second network node 402-2.

FIG. 6 shows another high-level call flow diagram 600 illustrating techniques for generating security keys for wireless communication systems, in accordance with some aspects of the present disclosure. The call flow diagram 600 illustrated in FIG. 6 includes a UE 404, the first network node 402-1, the second network node 402-2, at least one third network node 402-3, and the core network 408 (or a core network node). The at least one third network node 402-3 may include one or more network nodes 402. It may be noted that some aspects of the various operations of FIG. 6 may be similar to corresponding operations of FIG. 5 and the same have not been reiterated for the sake of brevity.

At operation 602, when the UE 404 is powered ON, the UE 404 may initiate an initial attach process or connection setup procedure to establish a connection with a wireless network (e.g., the wireless communication system 400) via the first network node 402-1.

At operation 604, the first network node 402-1 may identify the second network node 402-2 and the at least one third network node 402-3 configured to serve the UE 404. The second network node 402-2 and the at least one third network node 402-3 may be neighboring the first network node 402-1. The UE 404 may continuously monitor signal strength and signal quality from neighboring network nodes and may send measurement reports to the first network node 402-1 including measurements of RSRP, RSRQ, SINR, etc. of the neighboring network nodes. The first network node 402-1 may identify at least one target network node based on one or more of the measurement reports received from the UE 404, a load associated with the first network node 402-1, mobility information of the UE 404, or capability information of the UE 404. The first network node 402-1 may evaluate its own loading conditions and if a current cell of the first network node 402-1 is congested, the first network node 402-1 may decide to offload the UE 404 to neighboring network node(s) for load balancing. The first network node 402-1 may also monitor mobility pattern of the UE 404 (e.g., a direction of movement of the UE 404) for identifying the target network node(s). The first network node 402-1 may also evaluate the capability information of the UE 404 to determine whether the UE 404 is capable of dual connectivity and/or carrier aggregation, which frequency bands the UE 404 can operate on, but not limited thereto. Consider that after analyzing the measurement reports, load conditions, mobility information, and/or capability information, the first network node 402-1 identifies the second network node 402-2 and the at least one third network node 402-3 as the target network nodes configured to serve the UE 404 (e.g., suitable for certain features of 6G like Dual Connectivity, Handover, Carrier Aggregation, but not limited thereto). After identifying the second network node 402-2 and the at least one third network node 402-3, the first network node 402-1 may configure the second network node 402-2 and the at least one third network node 402-3 for serving the UE 404. Specifically, the first network node 402-1 may configure the second cell group associated with the second network node 402-2 and at least one third cell group associated with the at least one third network node 402-3 as the target cell groups.

At operation 606, the first network node 402-1 may communicate with the second network node 402-2 for cell group configuration or to configure the second cell group associated with the second network node 402-2 as a target cell group for serving the UE 404. In some examples, the first network node 402-1 may provide information to the second network node 402-2 about radio resources required for connecting and communicating with the UE 404. After receiving a CG configuration message from the first network node 402-1, the second network node 402-2 may configure and/or allocate specified radio resources for the second cell group to connect and communicate with the UE 404. The second network node 402-2 may also transmit information related to the allocated radio resources to the first network node 402-1 including uplink/downlink scheduling resources, frequency allocation, cell group configuration, and other configuration parameters allocated for communicating with the UE 404.

At operation 608, the second network node 402-2 may transmit a request message to the core network 408 requesting a security key corresponding to the second network node 402-2. The core network 408 may generate a second security key K_{6G-RAN2} corresponding to the second network node 402-2. The core network 408 may use a predefined Key Derivation Function (KDF) for generating the second security key K_{6G-RAN2}. At operation 610, the core network 408 may transmit a response message including the generated second security key K_{6G-RAN2} to the second network node 402-2. The second security key K_{6G-RAN2} may be used by the second network node 402-2 for securing data communicated (e.g., transmitted and/or received) between the UE 404 and the second network node 402-2.

At operation 612, the first network node 402-1 may communicate with the at least one third network node 402-3 for preparation of the at least one third cell group or to additionally configure the at least one third cell group as the target cell group(s) for serving the UE 404. In some examples, the first network node 402-1 may provide information to each of the at least one third network node 402-3 about radio resources required for connecting and communicating with the UE 404. After receiving CG preparation message(s) from the first network node 402-1, the at least one third network node 402-3 may configure and/or allocate specified radio resources for the at least one third cell group to connect and communicate with the UE 404. The at least one third network node 402-3 may also transmit information related to the allocated radio resources to the first network node 402-1 including uplink/downlink scheduling resources, frequency allocation, cell group configuration, and other configuration parameters allocated for communicating with the UE 404.

At operation 614, each network node of the at least one third network node 402-3 may transmit a request message to the core network 408 requesting a security key corresponding to the network node. The core network 408 may generate at least one third security key K_{6G-RAN3} corresponding to the at least one third network node 402-3. The core network 408 may use one or more predefined KDFs for generating the at least one third security key K_{6G-RAN3}. At operation 616, the core network 408 may transmit one or more response messages to the at least one third network node 402-3. Each of the one or more response messages may include a respective security key of the at least one third security key K_{6G-RAN3}. The at least one third security key K_{6G-RAN3} may be used by the at least one third network node 402-3 for securing data communicated (e.g., transmitted and/or received) between the UE 404 and the at least one third network node 402-3.

At operation 618, after identifying the second network node 402-2 and the at least one third network node 402-3, the first network node 402-1 may transmit a request message to the core network 408 (e.g., to the AMF of the core network 408) requesting key generation information for the second network node 402-2 and the at least one third network node 402-3. The request message may comprise identity information (e.g., RAN Global IDs) of the second network node 402-2 and the at least one third network node 402-3 so that the key generation information is provided for the correct network nodes. The request may be sent as an NGAP message. In one example, the request may be sent as an AS Security Context Request. In another example, a new NGAP message may be introduced for transmitting the request message to the core network 408.

At operation 620, upon receiving the request, the core network 408 prepares separate key generation information for each network node 402-n of the second network node 402-2 and the at least one third network node 402-3 and sends a response message to the first network node 402-1 including the key generation information for each network node 402-n. The key generation information may include security material or parameters for deriving security keys corresponding to the second and third network nodes 402-2, 402-3. The security material for a particular network node 402-n (where n is any integer greater than 1) of the second network node 402-2 and the at least one third network node 402-3 may include one or more parameters. The one or more parameters may include a CGI which identifies a cell group (e.g., the second and third cell groups) where the particular network node 402-n belongs, a network node identifier which is a unique identifier for the particular network node 402-n, a counter (e.g., NCC) to prevent security key reuse, and a random number. In one example, the core network 408 may send the response message as a part of an existing NGAP message (e.g., AS security context response). In another example, a new NGAP message may be introduced for transmitting the response message from the core network 408.

The first network node 402-1 may receive the response message from the core network 408. The response message may comprise separate key generation information corresponding to each network node 402-n of the second network node 402-2 and the at least one third network node 402-3. It may be noted that the key generation information of a network node 402-n is unique to that network node 402-n in the communication system 400. In other words, the key generation information of the network node 402-n in the communication system 400 is distinct and no two network nodes in the communication system 400 share the same key generation information. Further, the key generation information of each network node 402-n of the second network node 402-2 and the at least one third network node 402-3 is independent of other network nodes of the communication system 400, which means the key generation information of the network node 402-n does not depend on key generation information of any other network node in the communication system 400.

At operation 622, the first network node 402-1 may transmit a message comprising the key generation information to the UE 404. The key generation information received from the core network 408 permits the UE 404 to generate the second security key K_{6G-RAN2} corresponding to the second network node 402-2 and generate the at least one third security key K_{6G-RAN3} corresponding to the at least one third network node 402-3. The message may be an RRC Reconfiguration message which is used for updating configuration of the UE 404. The message may comprise additional information related to configuration of the second and third network nodes 402-2, 402-3 e.g., the radio resource allocation (including uplink/downlink scheduling resources, frequency allocation), cell group configuration, and other configuration parameters needed for communication with the second and third network nodes 402-2, 402-3. In one example, the core network 408 may cipher the key generation information so that the first network node 402-1 cannot read or modify the key generation information. The first network node 402-1 simply acts as a relay and forwards the key generation information to the UE 404. Such ciphering ensures that mainly the UE 404 may extract the key generation information.

The UE 404 may receive, from the first network node 402-1, the message comprising the key generation information which permits the UE 404 to generate the second security key K_{6G-RAN2} corresponding to the second network node 402-2 and generate the at least one third security key K_{6G-RAN3} corresponding to the at least one third network node 402-3. As discussed in connection with operation 622, the message may be an RRC Reconfiguration message and may comprise additional information related to configuration of the second network node 402-2 and the at least one third network node 402-3.

At operation 624, the UE 404 may generate the second security key K_{6G-RAN2} and the at least one third security key K_{6G-RAN3} based at least in part on the key generation information received from the first network node 402-1. Specifically, the UE 404 may process the received message to extract the key generation information for each network node 402-n of the second network node 402-2 and the at least one third network node 402-3. The UE 404 may then apply a predefined KDF on the respective key generation information for generating the second security key K_{6G-RAN2} and the at least one third security key K_{6G-RAN3}. Specifically, for each network node 402-n of the second network node 402-2 and the at least one third network node 402-3, the UE 404 may process respective key generation information of the network node 402-n by applying a predefined KDF and generates a security key K_{6G-RANn} corresponding to the network node 402-n. In one example, the UE 404 may generate the security key K_{6G-RANn} of the network node 402-n based at least in part on the key generation information for the network node 402-n and the anchor key shared between the UE 404 and the core network 408. Specifically, the UE 404 may generate the security key K_{6G-RANn} for the network node 402-n as per below expression (2):

K_{6G-RANn}=KDF(K_{AMF}, KGI) (2)

### Where:

K_{6G-RANn} is the security key for the network node 402-n of the second network node 402-2 and the at least one third network node 402-3.
KDF is the predefined Key Derivation Function.
K_{AMF} is the anchor key shared between the UE 404 and the core network 408.
KGI is the key generation information corresponding to the network node 402-n.

Once the UE 404 generates the security keys of the second network node 402-2 and the at least one third network node 402-3, the UE 404 may send an RRC Reconfiguration Complete message to the first network node 402-1 which may inform the second network node 402-2 and the at least one third network node 402-3 of the configuration results for the second network node 402-2 and the at least one third network node 402-3. The second network node 402-2 and the at least one third network node 402-3 may start communicating with the UE 404 securely using the respective security keys.

At operation 626, the UE 404 may establish a second connection (e.g., an RRC Connection) via the second network node 402-2. In one example, the UE 404 may establish the second RRC connection while maintaining the first RRC connection (e.g., in case of dual connectivity scenario). In case of Handover, the UE 404 may release the first RRC connection and communicate with the second network node 402-2 via the second RRC connection.

At operation 628, the UE 404 may start communicating (e.g., transmitting and/or receiving) data, secured using the second security key K_{6G-RAN2}, between the UE 404 and the second network node 402-2, upon establishing the second RRC connection with the second network node 402-2. Specifically, since the same second security key K_{6G-RAN2} is available at the UE 404 and the second network node 402-2, the UE 404 may encrypt data to be transmitted to the second network node 402-2 (e.g., using the second security key K_{6G-RAN2} generated/available at the UE 404) and then transmit the encrypted data to the second network node 402-2. The second network node 402-2 may decrypt the encrypted data received from the UE 404 (e.g., using the second security key K_{6G-RAN2} which is received from the core network 408 and which is available at the second network node 402-2). Likewise, the second network node 402-2 may encrypt data to be transmitted to the UE 404 (e.g., using the second security key K_{6G-RAN2} received from the core network 408) and then transmit the encrypted data to the UE 404. The UE 404 may decrypt the data received from the second network node 402-2 using the second security key K_{6G-RAN2} generated at the UE 404. In some examples, the UE 404 and the second network node 402-2 may derive additional security keys based on the second security key K_{6G-RAN2} for services provided by the second network node 402-2. The UE 404 and the second network node 402-2 may communicate (e.g., transmit and/or receive) data, secured using the additional security keys, between the UE 404 and the second network node 402-2.

At operation 630, the UE 404 may establish at least one third connection (e.g., an RRC Connection) via the at least one third network node 402-3. In case of Handover, the UE 404 may release the first and second RRC connections and communicate with the at least one third network node 402-3 via the at least one third RRC connection.

At operation 632, the UE 404 may start communicating (e.g., transmitting and/or receiving) data, secured using the at least one third security key K_{6G-RAN3}, between the UE 404 and the at least one third network node 402-3, upon establishing the at least one third RRC connection with the at least one third network node 402-3. Specifically, the UE 404 may encrypt data to be transmitted to the at least one third network node 402-3 (e.g., using the at least one third security key K_{6G-RAN3} generated/available at the UE 404) and then transmit the encrypted data to the at least one third network node 402-3. The at least one third network node 402-3 may decrypt the encrypted data received from the UE 404 (e.g., using the at least one third security key K_{6G-RAN3} which is received from the core network 408 and which is available at the third network node 402-3). Likewise, the at least one third network node 402-3 may encrypt data to be transmitted to the UE 404 (e.g., using the at least one third security key K_{6G-RAN3} received from the core network 408) and then transmit the encrypted data to the UE 404. The UE 404 may decrypt the data received from the at least one third network node 402-3 using the at least one third security key K_{6G-RAN3} generated at the UE 404. In some examples, the UE 404 and the at least one third network node 402-3 may derive additional security keys based on the at least one third security key K_{6G-RAN3} for services provided by the at least one third network node 402-3. The UE 404 and the at least one third network node 402-3 may communicate (e.g., transmit and/or receive) data, secured using the additional security keys, between the UE 404 and the at least one third network node 402-3.

In one example, the core network 408 may generate the second security key K_{6G-RAN2} and the at least one third security key K_{6G-RAN3} based at least in part on the key generation information and the unique anchor key which are already available with the core network 408. Specifically, for each network node 402-n of the second network node 402-2 and the at least one third network node 402-3, the core network 408 may generate the security key K_{6G-RANn} of the network node 402-n based at least in part on the key generation information for the network node 402-n and the anchor key shared between the UE 404 and the core network 408. The core network 408 may use the predefined KDF for generating the second security key K_{6G-RAN2} and the at least one third security key K_{6G-RAN3}, as described in connection with expression (2). It may be noted that for each network node 402-n of the second network node 402-2 and the at least one third network node 402-3, the core network 408 may generate the security key K_{6G-RANn} of the network node 402-n independent of security keys of the other network node.

It may be noted that the core network 408 may transmit the second security key K_{6G-RANn} of the network node 402-n anytime after receiving the request for the security key from the network node 402-n (e.g., at operations 608 or 614) but before operation 626. However, if the network node 402-n does not have the second security key K_{6G-RANn} when receiving a connection request from the UE 404 (e.g., at operation 626 or 630), the network node 402-n may transmit a request to the core network 408 for the security key K_{6G-RANn} and in response the core network 408 may send the security key K_{6G-RANn} to the network node 402-n. For example, if the second network node 402-2 does not have the second security key K_{6G-RAN2} when receiving a connection request from the UE 404 at operation 626, the second network node 402-2 may transmit a request to the core network 408 for the second security key K_{6G-RAN2} and in response the core network 408 may send the second security key K_{6G-RAN2} to the second network node 402-2. Likewise, if the at least one third network node 402-3 does not have the at least one third security key K_{6G-RAN2} when receiving a connection request from the UE 404 at operation 630, the at least one third network node 402-3 may transmit a request to the core network 408 for the at least one third security key K_{6G-RAN3} and in response the core network 408 may send the at least one third security key K_{6G-RAN3} to the at least one third network node 402-3.

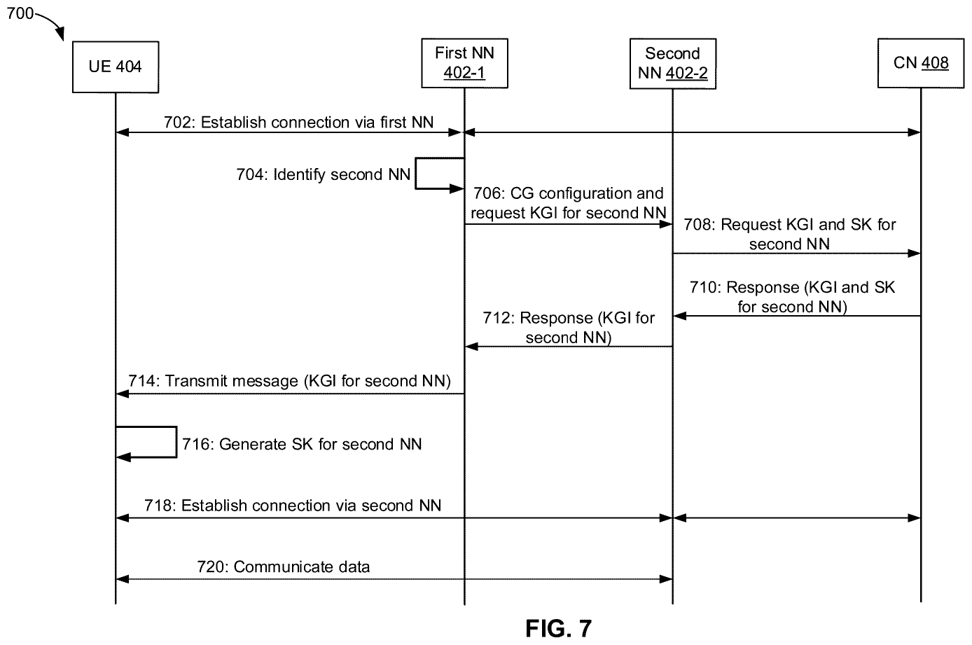

FIG. 7 shows another high-level call flow diagram 700 illustrating techniques for generating security keys for wireless communication systems, in accordance with some aspects of the present disclosure. The call flow diagram 700 illustrated in FIG. 7 includes the UE 404, the first network node 402-1, the second network node 402-2, and the core network 408 (or a core network node). It may be noted that some aspects of the various operations of FIG. 7 may be similar to corresponding operations of FIGS. 5-6 and the same have not been reiterated for the sake of brevity.

At operation 702, when the UE 404 is powered ON, the UE 404 may initiate an initial attach process or connection setup procedure to establish a connection with the wireless network (e.g., the wireless communication system 400) via the first network node 402-1.

At operation 704, the first network node 402-1 may identify the second network node 402-2 configured to serve the UE 404. The second network node 402-2 may be neighboring the first network node 402-1. The first network node 402-1 may identify the second network node 402-2 based on one or more of: measurement reports received from the UE 404, a load associated with the first network node 402-1, mobility information of the UE 404, or capability information of the UE 404. After identifying the second network node 402-2, the first network node 402-1 may configure the second network node 402-2 for serving the UE 404. Specifically, the first network node 402-1 may configure the second cell group associated with the second network node 402-2 as the target cell group for serving the UE 404.

At operation 706, after identifying the second network node 402-2, the first network node 402-1 may communicate with the second network node 402-2 for cell group configuration and may request key generation information for the second network node 402-2. Specifically, the first network node 402-1 may transmit a message to the second network node 402-2 for configuring the second cell group associated with the second network node 402-2 as the target cell group for serving the UE 404. The message may comprise a request for key generation information for the second network node 402-2.

At operation 708, upon receiving the request message from the first network node 402-1, the second network node 402-2 may send a request message to the core network 408 (e.g., to the AMF of the core network 408) requesting key generation information and a security key for the second network node 402-2. The request message to the core network 408 may comprise identity information (e.g., RAN Global ID) of the second network node 402-2 so that the key generation information and the security key are provided for the correct network node. The request may be sent as a NGAP message. In one example, the request may be sent as the AS Security Context Request. In another example, a new NGAP message may be introduced for transmitting the request.

At operation 710, upon receiving the request, the core network 408 may generate/prepare the key generation information for the second network node 402-2. The core network 408 may also generate a second security key K_{6G-RAN2} corresponding to the second network node 402-2. The core network 408 may send a response message to the second network node 402-2. The core network 408 may send the response message as a part of an existing NGAP message (e.g., AS security context response) or a new NGAP message may be introduced for transmitting the response. The second network node 402-2 may receive the response message from the core network 408, the response message may comprise the key generation information and the second security key K_{6G-RAN2} corresponding to the second network node 402-2.

At operation 712, the second network node 402-2 may keep the second security key K_{6G-RAN2} with itself and transmit another response message to the first network node 402-1 with the received key generation information. The first network node 402-1 may receive the response message from the second network node 402-2, the response message may comprise the key generation information corresponding to the second network node 402-2.

At operation 714, the first network node 402-1 may transmit a message comprising the received key generation information to the UE 404 to permit the UE 404 to generate the second security key K_{6G-RAN2} corresponding to the second network node 402-2. The UE 404 may receive, from the first network node 402-1, the message comprising the key generation information configured to generate the second security key K_{6G-RAN2} corresponding to the second network node 402-2.

At operation 716, the UE 404 may generate the second security key K_{6G-RAN2} corresponding to the second network node 402-2 based at least in part on the key generation information received from the first network node 402-1. In one example, the UE 404 may generate the second security key K_{6G-RAN2} based at least in part on the key generation information and the anchor key shared between the UE 404 and the core network 408. Once the UE 404 generates the second security key K_{6G-RAN2} of the second network node 402-2, the UE 404 may send an RRC Reconfiguration Complete message to the first network node 402-1 which may inform the second network node 402-2 of the configuration results for the second network node 402-2. The second network node 402-2 may start communicating with the UE 404 securely using the second security key K_{6G-RAN2}.

At operation 718, the UE 404 may establish a second connection (e.g., an RRC Connection) via the second network node 402-2. In one example, the UE 404 may establish the second RRC connection while maintaining the first RRC connection (e.g., in case of dual connectivity scenario). In case of Handover, the UE 404 may release the first RRC connection and communicate with the second network node 402-2 via the second RRC connection.

At operation 720, the UE 404 may start communicating (e.g., transmitting and/or receiving) data, secured using the second security key K_{6G-RAN2}, between the UE 404 and the second network node 402-2, upon establishing the second RRC connection with the second network node 402-2. Specifically, the UE 404 may encrypt data to be transmitted to the second network node 402-2 using the second security key K_{6G-RAN2} generated at the UE 404 and may decrypt the data received from the second network node 402-2 using the second security key K_{6G-RAN2} which is generated at the UE 404. Likewise, the second network node 402-2 may encrypt data to be transmitted to the UE 404 (e.g., using the second security key K_{6G-RAN2} which is received from the core network 408) and may decrypt the data received from the UE 404 (e.g., using the second security key K_{6G-RAN2} received from the core network 408). In some examples, the UE 404 and the second network node 402-2 may derive additional security keys based on the second security key K_{6G-RAN2} for services provided by the second network node 402-2. The UE 404 and the second network node 402-2 may communicate (e.g., transmit and/or receive) data, secured using the additional security keys, between the UE 404 and the second network node 402-2.

In one example, instead of transmitting a single request message for the key generation information and the second security key K_{6G-RAN2} (at operation 708), the second network node 402-2 may transmit separate request messages for the key generation information and the second security key K_{6G-RAN2}. Similarly, instead of transmitting a single response message including the key generation information and the second security key K_{6G-RAN2} (at operation 710), the core network 408 may transmit individual response messages for the key generation information and the second security key K_{6G-RAN2}. In one example, the core network 408 may generate the second security key K_{6G-RAN2} based at least in part on the key generation information and a unique anchor key which are already available with the core network 408.

It may be noted that the core network 408 may transmit the second security key K_{6G-RAN2} to the second network node 402-2 anytime after receiving the request for the second security key K_{6G-RAN2} but before operation 718. However, if the second network node 402-2 does not have the second security key K_{6G-RAN2} when receiving a connection request from the UE 404 at operation 718 (e.g., the second network node 402-2 did not receive the second security key K_{6G-RAN2} from the core network 408), the second network node 402-2 may transmit a request to the core network 408 for the second security key K_{6G-RAN2} and in response the core network 408 may transmit the second security key K_{6G-RAN2} to the second network node 402-2.

In some cases, after identifying the second network node 402-2, the first network node 402-1 may determine if the key generation information for the second network node 402-2 is available with the first network node 402-1. In one example, the first network node 402-1 may have previously received the key generation information for the second network node 402-2 from the core network 408. In another example, the first network node 402-1 may have previously received the key generation information for the second network node 402-2 e.g., if such information was exchanged as part of previous coordination procedures. Upon determining that the key generation information for the second network node 402-2 is available with the first network node 402-1, the first network node 402-1 may determine whether the key generation information is outdated or invalid e.g., due to key refresh events initiated by the core network 408. When the first network node 402-1 determines that valid and updated key generation information is available with the first network node 402-1, the first network node 402-1 may directly send the key generation information to the UE 404 (in operation 714) and may not request the key generation information from the second network node 402-2 in operation 706. When the first network node 402-1 determines that the key generation information is either not available with the first network node 402-1 or is outdated/invalid, the first network node 402-1 may request the key generation information from the second network node 402-2 in the operation 706. When the first network node 402-1 determines that the key generation information is outdated or invalid, the first network node 402-1 discards the outdated or invalid key generation information.

In some cases, after receiving the request for key generation information at operation 706, the second network node 402-2 may determine if the key generation information for the second network node 402-2 is available with the second network node 402-2. In one example, the second network node 402-2 may have previously received the key generation information for the second network node 402-2 from the core network 408 e.g., if such information was exchanged as part of previous coordination procedures. Upon determining that the key generation information is available with the second network node 402-2, the second network node 402-2 may determine whether the key generation information is outdated or invalid e.g., due to key refresh events initiated by the core network 408. When the second network node 402-2 determines that valid and updated key generation information is available with the second network node 402-2, the second network node 402-2 may directly send the key generation information to the first network node 402-1 (in operation 712) and may not request the key generation information from the core network 408 in operation 708. When the second network node 402-2 determines that the key generation information is either not available with the second network node 402-2 or is outdated/invalid, the second network node 402-2 may request the key generation information from the core network 408 in the operation 708. When the second network node 402-2 determines that the key generation information is outdated or invalid, the second network node 402-2 discards the outdated or invalid key generation information.

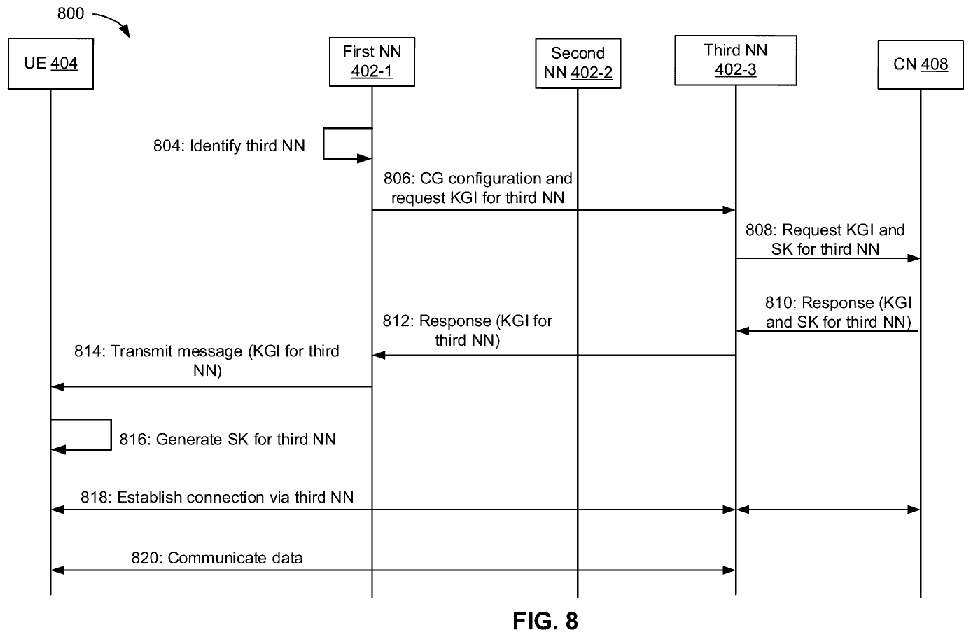

FIG. 8 shows another high-level call flow diagram 800 illustrating techniques for generating security keys for wireless communication systems, in accordance with some aspects of the present disclosure. The call flow diagram 800 illustrated in FIG. 8 includes the UE 404, the first network node 402-1, the second network node 402-2, a third network node 402-3, and the core network 408 (or a core network node). It may be noted that some aspects of the various operations of FIG. 8 may be similar to corresponding operations of FIGS. 5-7 and the same have not been reiterated for the sake of brevity. The call flow 800 of FIG. 8 has been described in the context of a single third network node 402-3. It may be noted that operations of the call flow 800 are equally applicable for generating security keys of more than one third network nodes 402-3.

At operation 804, after identifying a second network node 402-2 (e.g., as discussed in operation 704 of FIG. 7), the first network node 402-1 may identify a third network node 402-3 configured to serve the UE 404. The third network node 402-3 may be neighboring the first network node 402-1 and may be different from the second network node 402-2. The first network node 402-1 may identify the third network node 402-3 based on one or more of: measurement reports received from the UE 404, a load associated with the first network node 402-1, mobility information of the UE 404, or capability information of the UE 404. After identifying the third network node 402-3, the first network node 402-1 may configure the third network node 402-3 for serving the UE 404. Specifically, the first network node 402-1 may configure a third cell group associated with the third network node 402-3 as the target cell group for serving the UE 404.

At operation 806, after identifying the third network node 402-3, the first network node 402-1 may communicate with the third network node 402-3 for cell group configuration and may request key generation information for the third network node 402-3. Specifically, the first network node 402-1 may transmit a message to the third network node 402-3 for configuring the second cell group associated with the second network node 402-2 as the target cell group for serving the UE 404. The message may comprise a request for key generation information for the third network node 402-3.

At operation 808, upon receiving the request message from the first network node 402-1, the third network node 402-3 may send a request message to the core network 408 (e.g., to the AMF of the core network 408) requesting key generation information and a security key for the third network node 402-3. The request message to the core network 408 may comprise identity information of the third network node 402-3 (e.g., RAN Global ID) so that the key generation information and the security key are provided for the correct network node. The request may be sent as a NGAP message. In one example, the request may be sent as the AS Security Context Request. In another example, a new NGAP message may be introduced for transmitting the request.

At operation 810, upon receiving the request, the core network 408 may generate/prepare the key generation information for the third network node 402-3. The core network 408 may also generate a third security key K_{6G-RAN3} corresponding to the third network node 402-3. The core network 408 may send a response message to the third network node 402-3. The core network 408 may send the response message as a new NGAP message or as a part of an existing message (e.g., AS security context response). The third network node 402-3 may receive the response message from the core network 408, the response message may comprise the key generation information and the third security key K_{6G-RAN3} corresponding to the third network node 402-3.

At operation 812, the third network node 402-3 may keep the third security key K_{6G-RAN3} with itself and transmit a response message to the first network node 402-1 with the received key generation information. The first network node 402-1 may receive the response message from the third network node 402-3, the response message may comprise the key generation information corresponding to the third network node 402-3.

At operation 814, the first network node 402-1 may transmit a message comprising the received key generation information to the UE 404 to permit the UE 404 to generate a third security key K_{6G-RAN3} corresponding to the third network node 402-3. The UE 404 may receive from the first network node 402-1, the message comprising the key generation information configured to generate the third security key K_{6G-RAN3} corresponding to the third network node 402-3.

At operation 816, the UE 404 may generate the third security key K_{6G-RAN3} corresponding to the third network node 402-3 based at least in part on the key generation information received from the first network node 402-1. In one example, the UE 404 may generate the third security key K_{6G-RAN3} based at least in part on the key generation information and the anchor key shared between the UE 404 and the core network 408. Once the UE 404 generates the third security key K_{6G-RAN3} of the third network node 402-3, the UE 404 may send an RRC Reconfiguration Complete message to the first network node 402-1 which may inform the third network node 402-3 of the configuration results for the third network node 402-3. The third network node 402-3 may start communicating with the UE 404 securely using the third security key K_{6G-RAN3}.

At operation 818, the UE 404 may establish a third connection (e.g., an RRC Connection) via the third network node 402-3. In one example, the UE 404 may establish the third RRC connection while maintaining the first RRC connection (e.g., in case of dual connectivity scenario). In case of Handover, the UE 404 may release the first RRC connection and communicate with the third network node 402-3 via the third RRC connection.

At operation 820, the UE 404 may start communicating (e.g., transmitting and/or receiving) data, secured using the third security key K_{6G-RAN3}, between the UE 404 and the third network node 402-3, upon establishing the third RRC connection with the third network node 402-3. Specifically, the UE 404 may encrypt data to be transmitted to the third network node 402-3 using the third security key K_{6G-RAN3} generated at the UE 404 and may decrypt the data received from the third network node 402-3 using the third security key K_{6G-RAN3} which is generated at the UE 404. Likewise, the third network node 402-3 may encrypt data to be transmitted to the UE 404 (e.g., using the third security key K_{6G-RAN3} which is received from the core network 408) and may decrypt the data received from the UE 404 (e.g., using the third security key K_{6G-RAN3} which is received from the core network 408). In some examples, the UE 404 and the third network node 402-3 may derive additional security keys based on the third security key K_{6G-RAN3} for services provided by the third network node 402-3. The UE 404 and the third network node 402-3 may communicate (e.g., transmit and/or receive) data, secured using the additional security keys, between the UE 404 and the third network node 402-3.

In one example, instead of transmitting a single request message for the key generation information and the third security key K_{6G-RAN3} (at operation 808), the third network node 402-3 may transmit separate request messages for the key generation information and the third security key K_{6G-RAN3}. Similarly, instead of transmitting a single response message including the key generation information and the third security key K_{6G-RAN3} (at operation 810), the core network 408 may transmit individual response messages for the key generation information and the third security key K_{6G-RAN3}. In one example, the core network 408 may generate the third security key K_{6G-RAN3} based at least in part on the key generation information and a unique anchor key which are already available with the core network 408.

It may be noted that the core network 408 may transmit the third security key K_{6G-RAN3} to the third network node 402-3 anytime after receiving the request for the third security key K_{6G-RAN3} but before operation 818. However, if the third network node 402-3 does not have the third security key K_{6G-RAN3} when receiving a connection request from the UE 404 at operation 818 (e.g., the third network node 402-3 did not receive the third security key K_{6G-RAN3} from the core network 408), the third network node 402-3 may transmit a request to the core network 408 for the third security key K_{6G-RAN3} and in response, the core network 408 may transmit the third security key K_{6G-RAN3} to the third network node 402-3.

In some cases, after identifying the third network node 402-3, the first network node 402-1 may determine if the key generation information for the third network node 402-3 is available with the first network node 402-1. In one example, the first network node 402-1 may have previously received the key generation information for the third network node 402-3 from the core network 408. In another example, the first network node 402-1 may have previously received the key generation information for the third network node 402-3 from the third network node 402-3 e.g., if such information was exchanged as part of previous coordination procedures. Upon determining that the key generation information is available with the first network node 402-1, the first network node 402-1 may determine whether the key generation information is outdated or invalid e.g., due to key refresh events initiated by the core network 408. When the first network node determines that valid and updated key generation information is available with the first network node 402-1, the first network node 402-1 may directly send the key generation information to the UE 404 (in operation 814) and may not request the key generation information from the third network node 402-3 in operation 806. When the first network node 402-1 determines that the key generation information is either not available with the first network node 402-1 or is outdated/invalid, the first network node 402-1 requests the key generation information from the third network node 402-3 in the operation 806. When the first network node 402-1 determines that the key generation information is outdated or invalid, the first network node 402-1 discards the outdated or invalid key generation information.

In some cases, after receiving the request for key generation information at operation 806, the third network node 402-3 may determine if the key generation information for the third network node 402-3 is available with the third network node 402-3. In one example, the third network node 402-3 may have previously received the key generation information for the third network node 402-3 from the core network 408 e.g., if such information was exchanged as part of previous coordination procedures. Upon determining that the key generation information is available with the third network node 402-3, the third network node 402-3 may determine whether the key generation information is outdated or invalid e.g., due to key refresh events initiated by the core network 408. When the third network node 402-3 determines that valid and updated key generation information is available with the third network node 402-3, the third network node 402-3 may directly send the key generation information to the first network node 402-1 (in operation 812) and may not request the key generation information from the core network 408 in operation 808. When the third network node 402-3 determines that the key generation information is either not available with the third network node 402-3 or is outdated/invalid, the third network node 402-3 may request the key generation information from the core network 408 in the operation 808. When the third network node 402-3 determines that the key generation information is outdated or invalid, the third network node 402-3 discards the outdated or invalid key generation information.

In this manner, the techniques of the present disclosure facilitate independent key generation for communication systems (e.g., 6G communication systems) which may not have hierarchy between network nodes, unlike previous key management solutions (e.g., in 5G communication systems), where the secondary network node (SN) is dependent on the master network node (MN) and the secondary security keys K_{SN} are derived from the master security keys K_{MN}. The security keys generated in the present disclosure for different network nodes do not depend on each other and the different network nodes do not have access to each other's security keys, thereby providing security isolation between the different network nodes. Thus, the techniques of present disclosure prevent security vulnerabilities that may arise when a compromised network node leads to exposure of security keys.

In the present disclosure, since the security keys (e.g., K_{6G-RAN2}) of a network node (e.g., network node 402-2) are derived independently from security keys (e.g., K_{6G-RAN1}) of other network nodes (e.g., network node 402-1), a security breach at one network node does not affect the other network nodes. Additionally, the UE 404 does not need to wait for key derivation after performing handover because security keys of target network nodes are pre-configured at the UE 404, thereby reducing delays during UE mobility. The techniques of the present disclosure support multiple active AS root keys (e.g., K_{6G-RAN1}, K_{6G-RAN2}) for multiple network nodes 402-1, 402-2, 402-3 configured to serve the UE 404. In the present disclosure, the UE 404 may utilize the key generation information for the target network nodes 402-2, 402-3 to derive the security keys for subsequent UE handover(s) without receiving an RRC Reconfiguration message again, thereby reducing delays during UE mobility.

In the present disclosure, it has been described that the core network 408 generates independent and unique key generation information and security key for a target network node 402-n (which may be the second network node 402-2 or the at least one third network node 402-3). The key generation information of the target network node 402-n is shared with the UE 404 via a serving network node (e.g., the first network node 402-1) but the security key of the target network node 402-n is shared by the core network 408 only to the target network node 402-n (e.g., the serving network node does not know the security key of the target network node 402-n). The UE 404 then generates an independent and unique security key corresponding to the target network node 402-n based on the received key generation information and the anchor key. In summary, the operation of key generation is performed at the UE 404. In some cases, instead of delegating the operations of key generation at the UE 404, the techniques of the present disclosure may implement another solution. In this solution, the core network 408 may independently generate independent and unique security key for the target network node 402-n based on the respective key generation information available with the core network 408. The core network 408 may send the generated unique security key to the UE 404 in special containers (e.g., NAS messages) such that the intermediate network nodes (e.g., the first network node 402-1) are unable to decode or see the content of the special container. In this manner, the security keys are generated independently and there is no dependency or hierarchy of security keys among different network nodes. Moreover, since the network nodes cannot decode the special containers, the network nodes are not aware of security keys of other network nodes.

In the present disclosure, the interactions among different network nodes (e.g., for exchanging key generation information) may be over inter-RAN interfaces. In some cases, the inter-RAN interface may comprise Xn interfaces for exchanging the key generation information. For dual-connectivity related scenarios, the existing Xn messages may be modified to deliver the key generation information from at least one target network node 402-3, 402-3 to a source network node 402-1 (or a serving network node). For example, the Xn messages sent from SN to MN (e.g., in the 5G Dual Connectivity scenario) for SN addition/modification may be modified to include the key generation information of the at least one target network node 402-3, 402-3. Such messages may include SN Addition Request Acknowledge, SN Modification Required, SN Modification Request Acknowledge, but not limited thereto. For handover related scenarios, Xn messages sent from a target network node 402-3, 402-3 to the source network node 402-1 for handover preparation may be modified to include the key generation information of the target network node 402-3, 402-3. Such messages may include Handover Request Acknowledge, but not limited thereto. In some cases, new service based interface (SBI) application programming interfaces (APIs) may be introduced for the target network nodes 402-3, 402-3 to send their key generation information to the source network node 402-1. Such SBIs may include Node Configuration Request API, Node Configuration Response API, but not limited thereto.

The interactions between the network nodes 402 and the core network 408 (e.g., for receiving key generation information) may be via NGAP messages. In some cases, the network nodes 402 and the core network 408 may support certain messages to communicate security material for the at least one target node 402-3, 402-3. The NGAP messages may include AS Security context request (which is sent from the network nodes 402 to the core network 408), AS Security context response (which is sent from the core network 408 to the network nodes 402), but not limited thereto.

In some cases, the source network node 402-1 comprises information related to UE security capabilities and source security policy. The security capabilities are initially provided by the UE 404 during the AKA procedure and are stored in the core network 408 and the source network node 402-1. The UE security capabilities may indicate the security algorithms supported at the UE 404. The source network node 402-1 may send the UE security capabilities and the source security policy to the target network node 402-3, 402-3 and the target network node 402-3, 402-3 may decide security algorithms for the UE 404 based on the UE security capabilities and the source security policy.

It may be noted that the techniques of the present disclosure are not limited to the scenarios discussed in the present disclosure (e.g., dual connectivity, handover, and carrier aggregation) and in general, the techniques of the present disclosure are equally applicable for any procedure where two or more RAN nodes are interacting with each other.

While aspects of the present disclosure may be described herein using terminology commonly associated with a 5G or 6G RAT, aspects of the present disclosure can be applied to other RATs.

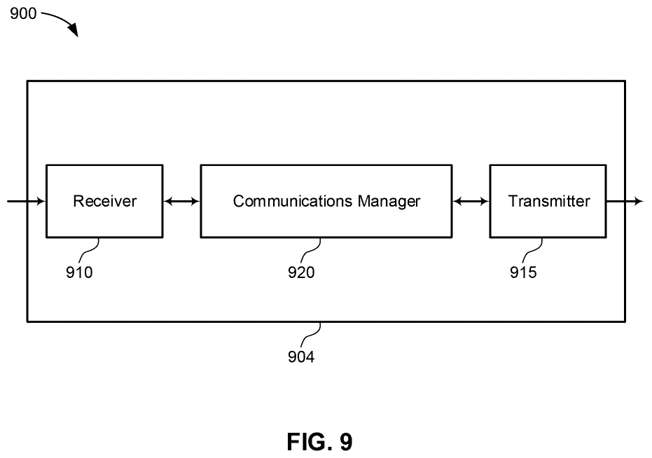

FIG. 9 shows a block diagram 900 of a device 904 that supports generating security keys for wireless communication systems, in accordance with one or more aspects of the present disclosure. The device 904 may be an example of aspects of a UE 104 or UE 404 as described herein. The device 904 may include a receiver 910, a transmitter 915, and a communications manager 920. The device 904 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related generating security keys for wireless communication systems). Information may be passed on to other components of the device 904. The receiver 910 may utilize a single antenna or a set of multiple antennas.

The transmitter 915 may provide a means for transmitting signals generated by other components of the device 904. For example, the transmitter 915 may transmit information such as packets, user data, control information, or any combination thereof associated with various information channels (e.g., control channels, data channels, information channels related to generating security keys for wireless communication systems). In some examples, the transmitter 915 may be co-located with the receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of generating security keys for wireless communications, as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., establishing, receiving, generating, securing, transmitting, communicating) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

Additionally, or alternatively, the communications manager 920 may support wireless communication at a UE in accordance with examples as disclosed herein. For example, the communications manager 920 may be configured as or otherwise support a means for establishing a first RRC connection between a UE 404 and a first network node 402-1. The communications manager 920 may be configured as or otherwise support a means for receiving, from the first network node 402-1, a message comprising key generation information configured to generate a security key corresponding to a second network node 402-2 neighboring the first network node 402-1. The communications manager 920 may be configured as or otherwise support a means for generating the security key corresponding to the second network node 402-2 based at least in part on the key generation information and an anchor key shared between the UE 404 and a core network 408.

By including or configuring the communications manager 920 in accordance with examples as described herein, the device 904 (e.g., a processor controlling or otherwise coupled with the receiver 910, the transmitter 915, the communications manager 920, or a combination thereof) may support techniques for generating security keys for communication systems.

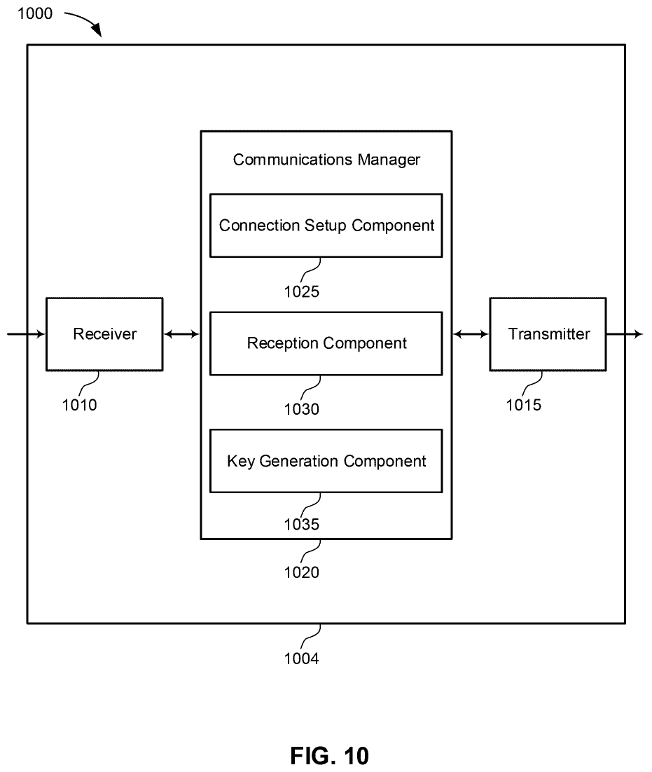

FIG. 10 shows a block diagram 1000 of a device 1004 that supports generating security keys for communication systems, in accordance with one or more aspects of the present disclosure. The device 1004 may be an example of aspects of a device 904 or a UE 104 or a UE 404 as described herein. The device 1004 may include a receiver 1010, a transmitter 1015, and a communications manager 1020. The device 1004 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to generating security keys for communication systems). Information may be passed on to other components of the device 1004. The receiver 1010 may utilize a single antenna or a set of multiple antennas.

The transmitter 1015 may provide a means for transmitting signals generated by other components of the device 1004. For example, the transmitter 1015 may transmit information such as packets, user data, control information, or any combination thereof associated with various information channels (e.g., control channels, data channels, information channels related to generating security keys for communication systems). In some examples, the transmitter 1015 may be co-located with the receiver 1010 in a transceiver module. The transmitter 1015 may utilize a single antenna or a set of multiple antennas.

The device 1004, or various components thereof, may be an example of means for performing various aspects of generating security keys for communication systems as described herein. For example, the communications manager 1020 may include a connection setup component 1025, a reception component 1030, a key generation component 1035, a data secure component, a communication component, or any combination thereof. The communications manager 1020 may be an example of aspects of a communications manager 920 as described herein. In some examples, the communications manager 1020, or various components thereof, may be configured to perform various operations (e.g., establishing, receiving, generating, transmitting, securing, communicating) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a UE in accordance with examples as disclosed herein. The connection setup component 1025 may be configured as or otherwise support a means for establishing a first RRC connection between a UE 404 and a first network node 402-1. The reception component 1030 may be configured as or otherwise support a means for receiving, from the first network node 402-1, a message comprising key generation information configured to generate a security key corresponding to a second network node 402-2 neighboring the first network node 402-1. The key generation component 1035 may be configured as or otherwise support a means for generating the security key corresponding to the second network node 402-2 based at least in part on the key generation information and an anchor key shared between the UE 404 and a core network 408.

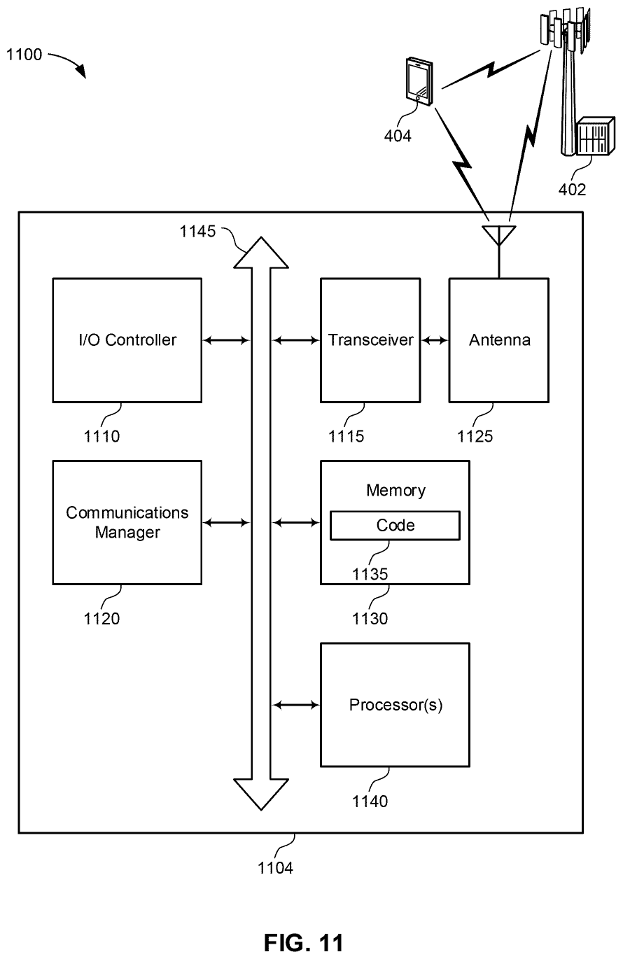

FIG. 11 shows a diagram of a system 1100 including a device 1104 that supports generating security keys for wireless communication systems, in accordance with one or more aspects of the present disclosure. The device 1104 may be an example of or include the components of a device 904, a device 1004, a UE 104, or a UE 404 as described herein. The device 1104 may communicate (e.g., wirelessly) with one or more network nodes 402, 102; one or more UEs 404, 104; or any combination thereof. The device 1104 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1104. The I/O controller 1110 may also manage peripherals not integrated into the device 1104. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1104 via the I/O controller 1110 or via hardware components controlled by the I/O controller 1110.

In some cases, the device 1104 may include a single antenna 1125. However, in some other cases, the device 1104 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 915, a transmitter 1015, a receiver 1210, a receiver 1010, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1104 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1104 to perform various functions (e.g., functions or tasks supporting security key generation for wireless communication systems). For example, the device 1104 or a component of the device 1104 may include a processor 1140 and memory 1130 coupled with or to the processor 1140, the processor 1140 and memory 1130 configured to perform various functions described herein.

Additionally, or alternatively, the communications manager 1120 may support wireless communication at a UE in accordance with examples as disclosed herein. For example, the communications manager 1120 may be configured as or otherwise support a means for establishing a first RRC connection between a UE 404 and a first network node 402-1. The communications manager 1120 may be configured as or otherwise support a means for receiving, from the first network node 402-1, a message comprising key generation information configured to generate a security key corresponding to a second network node 402-2 neighboring the first network node 402-1. The communications manager 1120 may be configured as or otherwise support a means for generating the security key corresponding to the second network node 402-2 based at least in part on the key generation information and an anchor key shared between the UE 404 and a core network 408.

By including or configuring the communications manager 1120 in accordance with examples as described herein, the device 1104 may provide various technical advantages such as enhancing security and mitigating risks associated with security key compromises, reducing delays during mobility transitions, improving the overall efficiency and security of UE-to-network communications.

In some examples, the communications manager 1120 may be configured to perform various operations (e.g., establishing, receiving, generating, securing, transmitting, communicating) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1104 to perform various aspects of security key generation for wireless communications as described herein, or the processor 1140 and the memory 1130 may be otherwise configured to perform or support such operations.

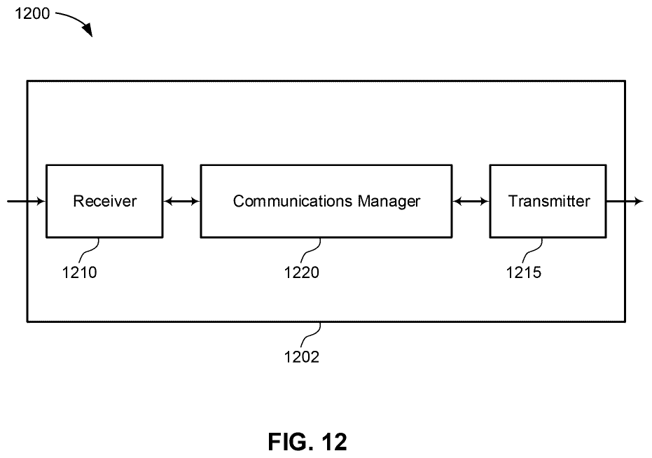

FIG. 12 shows a block diagram 1200 of a device 1202 that supports security key generation for wireless communication systems in accordance with one or more aspects of the present disclosure. The device 1202 may be an example of aspects of a network node or base station 102, 402 as described herein. In some examples, the device 1202 may be an example of a network node of a core network 408 (or a core network node). The device 1202 may include a receiver 1210, a transmitter 1215, and a communications manager 1220. The device 1202 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels related to generating security keys for communication systems). Information may be passed on to other components of the device 1202. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1202. For example, the transmitter 1215 may output information such as user data, control information, or any combination thereof (e.g., I/Q samples, symbols, packets, protocol data units, service data units) associated with various channels (e.g., control channels, data channels, information channels related to generating security keys for communication systems). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations thereof or various components thereof may be examples of means for performing various aspects of security key generation for wireless communications as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1220, the receiver 1210, the transmitter 1215, or various combinations or components thereof may be implemented in code (e.g., as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1220 may be configured to perform various operations (e.g., establishing, identifying, transmitting, receiving, configuring, associating) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

Additionally, or alternatively, the communications manager 1220 may support wireless communication at a network node in accordance with examples as disclosed herein. For example, the communications manager 1220 may be configured as or otherwise support a means for establishing a first RRC connection between a first network node 402-1 and a UE 404. The communications manager 1220 may be configured as or otherwise support a means for identifying a second network node 402-2 configured to serve the UE 404, where the second network node 402-2 is neighboring the first network node 402-1. The communications manager 1220 may be configured as or otherwise support a means for receiving key generation information for the second network node 402-2. The communications manager 1220 may be configured as or otherwise support a means for transmitting a message comprising the received key generation information to the UE 404.

By including or configuring the communications manager 1220 in accordance with examples as described herein, the device 1202 (e.g., a processor controlling or otherwise coupled with the receiver 1210, the transmitter 1215, the communications manager 1220, or a combination thereof) may support techniques for generating security keys for communication systems.

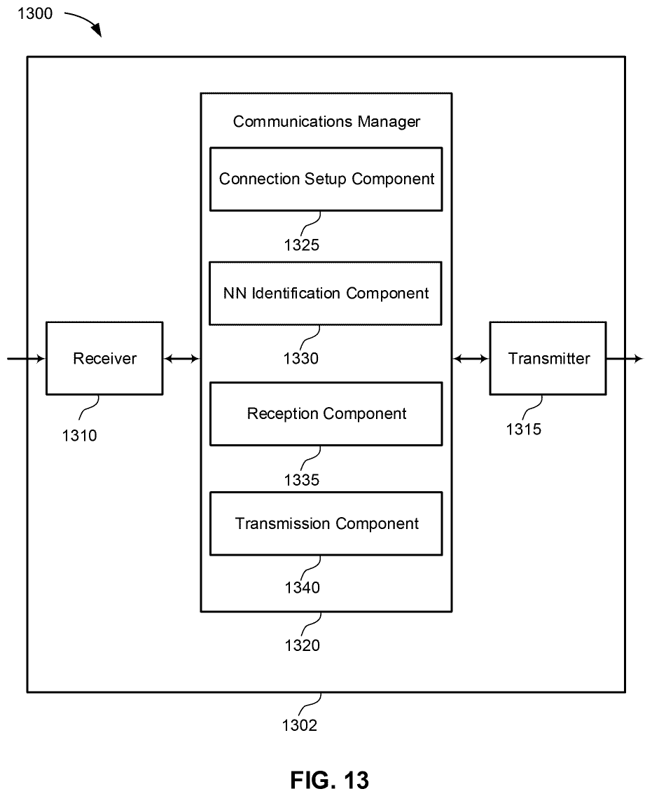

FIG. 13 shows a block diagram 1300 of a device 1302 that supports generating security keys for communication systems, in accordance with one or more aspects of the present disclosure. The device 1302 may be an example of aspects of a device 1202, a network node or base station 102, 402, or a network node of a core network 408, as described herein. The device 1302 may include a receiver 1310, a transmitter 1315, and a communications manager 1320. The device 1302 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels related to generating security keys for communication systems). Information may be passed on to other components of the device 1302. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1302. For example, the transmitter 1315 may output information such as user data, control information, or any combination thereof (e.g., I/Q samples, symbols, packets, protocol data units, service data units) associated with various channels (e.g., control channels, data channels, information channels, channels related to generating security keys for communication systems). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1302, or various components thereof, may be an example of means for performing various aspects of generating security keys for communication systems as described herein. For example, the communications manager 1320 may include a connection setup component 1325, a network node (NN) identification component 1330, a reception component 1335, a transmission component 1340, or any combination thereof. The communications manager 1320 may be an example of aspects of a communications manager 1220 as described herein. In some examples, the communications manager 1320, or various components thereof, may be configured to perform various operations (e.g., establishing, identifying, receiving, transmitting, configuring, associating) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication at a network node in accordance with examples as disclosed herein. The connection setup component 1325 may be configured as or otherwise support a means for establishing a first RRC connection between a first network node 402-1 and a UE 404. The NN identification component 1330 may be configured as or otherwise support a means for identifying a second network node 402-2 configured to serve the UE 404, where the second network node 402-2 is neighboring the first network node 402-1. The reception component 1335 may be configured as or otherwise support a means for receiving key generation information for the second network node 402-2. The transmission component 1340 may be configured as or otherwise support a means for transmitting a message comprising the received key generation information to the UE 404.

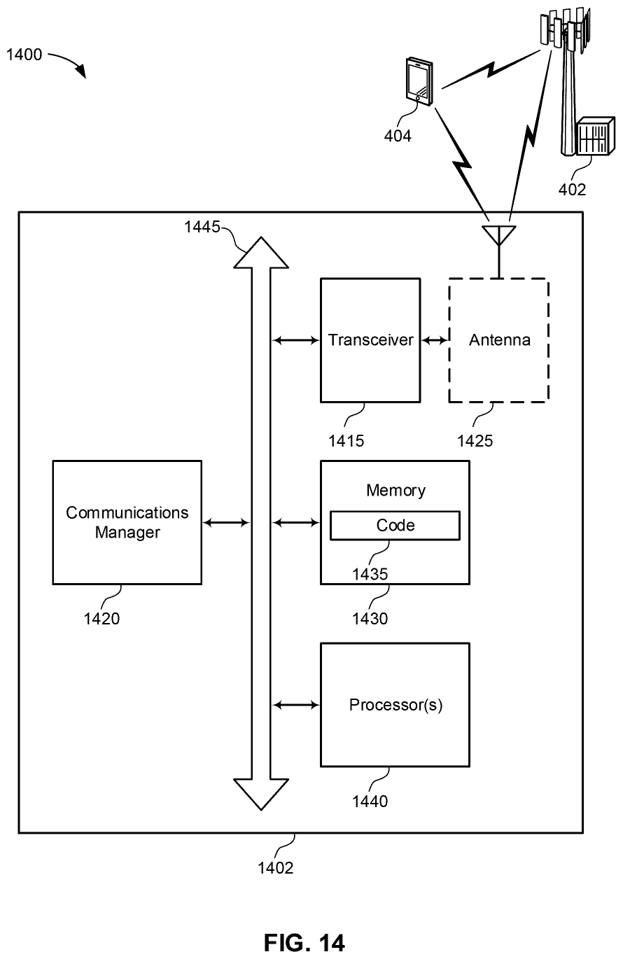

FIG. 14 shows a diagram of a system 1400 including a device 1402 that supports generating security keys for wireless communication systems, in accordance with one or more aspects of the present disclosure. The device 1402 may be an example of or include the components of a device 1202, a device 1302, a network node or base station 102, 402, or a network node of a core network 408, as described herein. The device 1402 may communicate with one or more network nodes 402, 102; one or more UEs 404, 104; or any combination thereof, which may include communications over one or more wired interfaces, over one or more wireless interfaces, or any combination thereof. The device 1402 may include components that support outputting and obtaining communications, such as a communications manager 1420, a transceiver 1415, an antenna 1425, a memory 1430, code 1435, and a processor 1440. These components may be in electronic communication or otherwise coupled (e.g., operatively, communicatively, functionally, electronically, electrically) via one or more buses (e.g., a bus 1445).

The transceiver 1415 may support bi-directional communications via wired links, wireless links, or both as described herein. In some examples, the transceiver 1415 may include a wired transceiver and may communicate bi-directionally with another wired transceiver. Additionally, or alternatively, in some examples, the transceiver 1415 may include a wireless transceiver and may communicate bi-directionally with another wireless transceiver. In some examples, the device 1402 may include one or more antennas 1425, which may be capable of transmitting or receiving wireless transmissions (e.g., concurrently). The transceiver 1415 may also include a modem to modulate signals, to provide the modulated signals for transmission (e.g., by one or more antennas 1425, by a wired transmitter), to receive modulated signals (e.g., from one or more antennas 1425, from a wired receiver), and to demodulate signals. In some implementations, the transceiver 1415 may include one or more interfaces, such as one or more interfaces coupled with the one or more antennas 1425 that are configured to support various receiving or obtaining operations, or one or more interfaces coupled with the one or more antennas 1425 that are configured to support various transmitting or outputting operations, or a combination thereof.

In some implementations, the transceiver 1415 may include or be configured for coupling with one or more processors or memory components that are operable to perform or support operations based on received or obtained information or signals, or to generate information or other signals for transmission or other outputting, or any combination thereof. In some implementations, the transceiver 1415, or the one or more antennas 1425, and one or more processors or memory components (for example, the processor 1440, or the memory 1430, or both), may be included in a chip or chip assembly that is installed in the device 1402. In some examples, the transceiver may be operable to support communications via one or more communications links (e.g., a communication link, a backhaul communication link, a mid-haul communication link, a fronthaul communication link).

The memory 1430 may include RAM and ROM. The memory 1430 may store computer-readable, computer-executable code 1435 including instructions that, when executed by the processor 1440, cause the device 1402 to perform various functions described herein. The code 1435 may be stored in a non-transitory computer-readable medium such as system memory or another type of memory. In some cases, the code 1435 may not be directly executable by the processor 1440 but may cause a computer (e.g., when compiled and executed) to perform functions described herein. In some cases, the memory 1430 may contain, among other things, a BIOS which may control basic hardware or software operation such as the interaction with peripheral components or devices.

The processor 1440 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1440 may be configured to operate a memory array using a memory controller. In some other cases, a memory controller may be integrated into the processor 1440. The processor 1440 may be configured to execute computer-readable instructions stored in a memory (e.g., the memory 1430) to cause the device 1402 to perform various functions (e.g., functions or tasks supporting security key generation for wireless communication systems). For example, the device 1402 or a component of the device 1402 may include a processor 1440 and memory 1430 coupled with the processor 1440, the processor 1440 and memory 1430 configured to perform various functions described herein. The processor 1440 may be an example of a cloud-computing platform (e.g., one or more physical nodes and supporting software such as operating systems, virtual machines, or container instances) that may host the functions (e.g., by executing code 1435) to perform the functions of the device 1402. The processor 1440 may be any one or more suitable processors capable of executing scripts or instructions of one or more software programs stored in the device 1402 (such as within the memory 1430). In some implementations, the processor 1440 may be a component of a processing system. A processing system may generally refer to a system or series of machines or components that receives inputs and processes the inputs to produce a set of outputs (which may be passed to other systems or components of, for example, the device 1402). For example, a processing system of the device 1402 may refer to a system including the various other components or subcomponents of the device 1402, such as the processor 1440, or the transceiver 1415, or the communications manager 1420, or other components or combinations of components of the device 1402. The processing system of the device 1402 may interface with other components of the device 1402 and may process information received from other components (such as inputs or signals) or output information to other components. For example, a chip or modem of the device 1402 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1402 may transmit information output from the chip or modem. Additionally, or alternatively, in some implementations, the one or more interfaces may refer to an interface between the processing system of the chip or modem and a receiver, such that the device 1402 may obtain information or signal inputs, and the information may be passed to the processing system. A person having ordinary skill in the art will readily recognize that a first interface also may obtain information or signal inputs, and a second interface also may output information or signal outputs.

In some examples, a bus 1445 may support communications of (e.g., within) a protocol layer of a protocol stack. In some examples, a bus 1445 may support communications associated with a logical channel of a protocol stack (e.g., between protocol layers of a protocol stack), which may include communications performed within a component of the device 1402, or between different components of the device 1402 that may be co-located or located in different locations (e.g., where the device 1402 may refer to a system in which one or more of the communications manager 1420, the transceiver 1415, the memory 1430, the code 1435, and the processor 1440 may be located in one of the different components or divided between different components).

In some examples, the communications manager 1420 may manage aspects of communications with a core network 408 (e.g., via one or more wired or wireless backhaul links). For example, the communications manager 1420 may manage the transfer of data communications for client devices, such as one or more UEs 404. In some examples, the communications manager 1420 may manage communications with other network nodes 102, 402 and may include a controller or scheduler for controlling communications with UEs 404 in cooperation with other network nodes 102, 402. In some examples, the communications manager 1420 may support an X2 interface within an LTE/LTE-A wireless communications network technology to provide communication between network nodes 102, 402.

Additionally, or alternatively, the communications manager 1420 may support wireless communication at a network node in accordance with examples as disclosed herein. For example, the communications manager 1420 may be configured as or otherwise support a means for establishing a first RRC connection between a first network node 402-1 and a UE 404. The communications manager 1420 may be configured as or otherwise support a means for identifying a second network node 402-2 configured to serve the UE 404, where the second network node 402-2 is neighboring the first network node 402-1. The communications manager 1420 may be configured as or otherwise support a means for receiving key generation information for the second network node 402-2. The communications manager 1420 may be configured as or otherwise support a means for transmitting a message comprising the received key generation information to the UE 404.

By including or configuring the communications manager 1420 in accordance with examples as described herein, the device 1402 may provide various technical advantages such as enhancing security and mitigating risks associated with security key compromises, reducing delays during mobility transitions, improving the overall efficiency and security of UE-to-network communications.

In some examples, the communications manager 1420 may be configured to perform various operations (e.g., receiving, transmitting, identifying, establishing, associating, configuring) using or otherwise in cooperation with the transceiver 1415, the one or more antennas 1425 (e.g., where applicable), or any combination thereof. Although the communications manager 1420 is illustrated as a separate component, in some examples, one or more functions described with reference to the communications manager 1420 may be supported by or performed by the transceiver 1415, the processor 1440, the memory 1430, the code 1435, or any combination thereof. For example, the code 1435 may include instructions executable by the processor 1440 to cause the device 1402 to perform various aspects of security key generation for wireless communication systems, as described herein, or the processor 1440 and the memory 1430 may be otherwise configured to perform or support such operations.

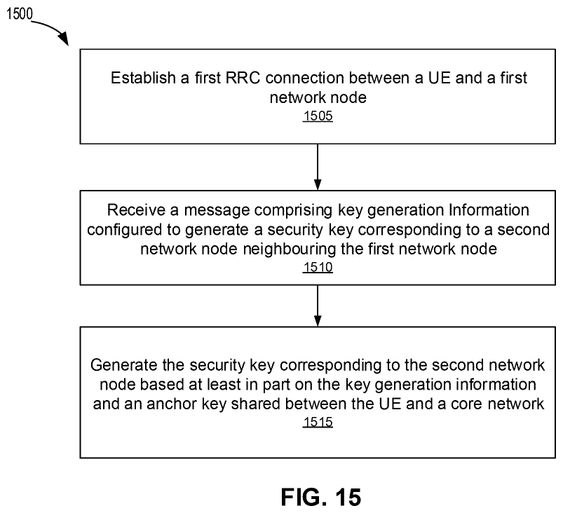

FIG. 15 shows a flowchart illustrating a method 1500 that supports generating security keys for wireless communication systems, in accordance with one or more aspects of the present disclosure. The operations of the method 1500 may be implemented by a UE or its components as described herein. For example, the operations of the method 1500 may be performed by a UE 104, 404 or by a device 904, 1004, 1104 as described with reference to FIGS. 9 through 11. In some examples, a UE may execute a set of instructions to control the functional elements of the UE to perform the described functions. Additionally, or alternatively, the UE may perform aspects of the described functions using special-purpose hardware.

At 1505, the method 1500 may include establishing a first RRC connection between the UE and a first network node. The operations of 1505 may be performed in accordance with examples as disclosed herein. In some examples, aspects of the operations of 1505 may be performed by a connection setup component 1025 as described with reference to FIG. 10.

At 1510, the method 1500 may include receiving, from the first network node, a message comprising key generation information configured to generate a security key corresponding to a second network node neighboring the first network node. The operations of 1510 may be performed in accordance with examples as disclosed herein. In some examples, aspects of the operations of 1510 may be performed by a reception component 1030 as described with reference to FIG. 10.

At 1515, the method may include generating the security key corresponding to the second network node based at least in part on the key generation information and an anchor key shared between the UE and a core network. The operations of 1515 may be performed in accordance with examples as disclosed herein. In some examples, aspects of the operations of 1515 may be performed by a key generation component 1035 as described with reference to FIG. 10.

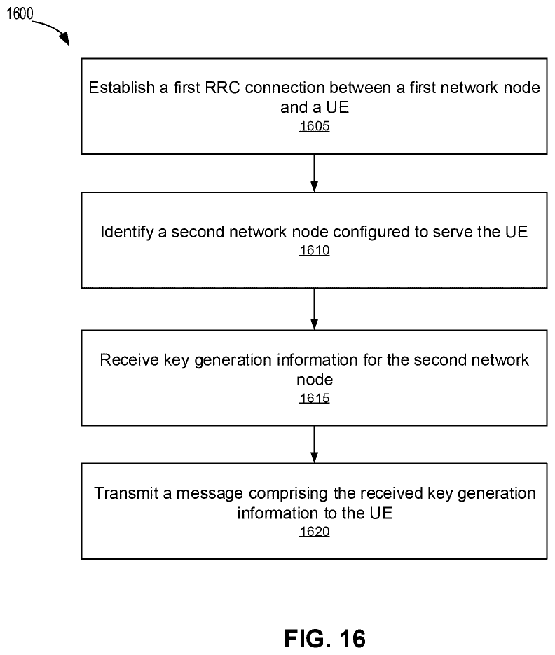

FIG. 16 shows a flowchart illustrating a method 1600 that supports generating security keys for wireless communication systems in accordance with one or more aspects of the present disclosure. The operations of the method 1600 may be implemented by a network node or its components as described herein. For example, the operations of the method 1600 may be performed by a network node 402, 102 or by a device 1202, 1302, 1402 as described with reference to FIGS. 12 through 14. In some examples, a network node may execute a set of instructions to control the functional elements of the network node to perform the described functions. Additionally, or alternatively, the network node may perform aspects of the described functions using special-purpose hardware.

At 1605, the method 1600 may include establishing a first RRC connection between a first network node and a UE. The operations of 1605 may be performed in accordance with examples as disclosed herein. In some examples, aspects of the operations of 1605 may be performed by a connection setup component 1325 as described with reference to FIG. 13.

At 1610, the method 1600 may include identifying a second network node configured to serve the UE. The second network node may be neighboring the first network node. The operations of 1610 may be performed in accordance with examples as disclosed herein. In some examples, aspects of the operations of 1610 may be performed by a NN identification component 1330 as described with reference to FIG. 13.

At 1615, the method 1600 may include receiving key generation information for the second network node, in response to identifying the second network node configured to serve the UE. The operations of 1615 may be performed in accordance with examples as disclosed herein. In some examples, aspects of the operations of 1615 may be performed by a reception component 1335 as described with reference to FIG. 13.

At 1620, the method may include transmitting a message comprising the received key generation information to the UE. The operations of 1620 may be performed in accordance with examples as disclosed herein. In some examples, aspects of the operations of 1620 may be performed by a transmission component 1340 as described with reference to FIG. 13.

It should be noted that the methods described herein describe possible implementations, and that the operations and the steps may be rearranged or otherwise modified and that other implementations are possible. Further, aspects from two or more of the methods may be combined.

It may be noted here that the subject matter of some or all aspects described with reference to FIGS. 4-8 may be relevant for the methods 1500, 1600 and the same is not repeated for the sake of brevity.

The following provides an overview of aspects/examples of the present disclosure:

Aspect 1. A user equipment (UE) for wireless communication, the UE comprising: one or more memories; and one or more processors coupled to the one or more memories and individually or collectively configured to cause the UE to: establish a first radio resource control (RRC) connection between the UE and a first network node; receive, from the first network node, a message comprising key generation information configured to generate a security key corresponding to a second network node neighboring the first network node; and generate the security key corresponding to the second network node based at least in part on the key generation information and an anchor key shared between the UE and a core network.

Aspect 2. The UE of aspect 1, wherein the one or more processors are further configured to cause the UE to: establish, while maintaining the first RRC connection, a second RRC connection with the second network node; and communicate data secured using the security key between the UE and the second network node, upon establishing the second RRC connection with the second network node.

Aspect 3. The UE of aspect 1 or 2, wherein the anchor key is unique to the UE.

Aspect 4. The UE of any of aspects 1-3, wherein the security key and the key generation information corresponding to the second network node are unique to the second network node and independent of other network nodes.

Aspect 5. The UE of any of aspects 1-4, wherein the key generation information comprises at least one of a cell group identifier, a network node identifier, a counter, or a random number.

Aspect 6. The UE of any of aspects 1-5, wherein the first network node is associated with a first cell group and the second network node is associated with a second cell group, wherein the first cell group and the second cell group are hierarchically independent from each other and are associated with the core network, and wherein the first cell group is configured as a serving cell group for the UE and the second cell group is configured as a target cell group for dual-connectivity or handover of the UE.

Aspect 7. The UE of any of aspects 1-6, wherein the first network node and the second network node comprise a first base station and a second base station respectively, implemented in a radio access network.

Aspect 8. The UE of any of aspects 1-7, wherein the message further comprises key generation information configured to generate at least one security key corresponding to at least one third network node neighboring the first network node, the at least one security key corresponding to the at least one third network node being configured to secure data communicated between the UE and the at least one third network node.

Aspect 9. A method for wireless communication, the method comprising: at a user equipment (UE), establishing a first radio resource control (RRC) connection between the UE and a first network node; at the UE, receiving, from the first network node, a message comprising key generation information configured to generate a security key corresponding to a second network node neighboring the first network node; and at the UE, generating the security key corresponding to the second network node based at least in part on the key generation information and an anchor key shared between the UE and a core network.

Aspect 10. The method of aspect 9, further comprising: establishing, while maintaining the first RRC connection, a second RRC connection with the second network node; and communicating data secured using the security key between the UE and the second network node, upon establishing the second RRC connection with the second network node.

Aspect 11. The method of aspect 9 or 10, wherein the anchor key is unique to the UE.

Aspect 12. The method of any of aspects 9-11, wherein the security key and the key generation information corresponding to the second network node are unique to the second network node and independent of other network nodes.

Aspect 13. The method of any of aspects 9-12, wherein the key generation information comprises at least one of a cell group identifier, a network node identifier, a counter, or a random number.

Aspect 14. The method of any of aspects 9-13, wherein the first network node is associated with a first cell group and the second network node is associated with a second cell group, wherein the first cell group and the second cell group are hierarchically independent from each other and are associated with the core network, and wherein the first cell group is configured as a serving cell group for the UE and the second cell group is configured as a target cell group for dual-connectivity or handover of the UE.

Aspect 15. The method of any of aspects 9-14, wherein the message further comprises key generation information configured to generate at least one security key corresponding to at least one third network node neighboring the first network node, the at least one security key corresponding to the at least one third network node being configured to secure data communicated between the UE and the at least one third network node.

Aspect 16. A first network node for wireless communication, the first network node comprising: one or more memories; and one or more processors coupled to the one or more memories and individually or collectively configured to cause the first network node to: establish a first radio resource control (RRC) connection between the first network node and a user equipment (UE); identify a second network node configured to serve the UE, wherein the second network node is neighboring the first network node; in response to identifying the second network node configured to serve the UE, receive key generation information for the second network node; and transmit a message comprising the received key generation information to the UE.

Aspect 17. The first network node of aspect 16, wherein the one or more processors are further configured to cause the first network node to: transmit a request to a core network requesting the key generation information for the second network node, wherein the request comprises identity information of the second network node; and receive a response from the core network, the response comprising the key generation information for the second network node.

Aspect 18. The first network node of aspect 17, wherein: to transmit the request to the core network requesting the key generation information for the second network node, the one or more processors are configured to cause the first network node to transmit the request to the core network requesting the key generation information for the second network node and key generation information for at least one third network node neighboring the first network node; and to receive the response from the core network, the one or more processors are configured to cause the first network node to receive the response comprising the key generation information for the second network node and the key generation information for the at least one third network node.

Aspect 19. The first network node of aspect 16, wherein to receive the key generation information for the second network node, the one or more processors are configured to cause the first network node to: receive the key generation information from the second network node.

Aspect 20. The first network node of any of aspects 16-19, wherein to identify the second network node configured to serve the UE, the one or more processors are configured to cause the first network node to: identify the second network node based on one or more of measurement reports received from the UE, a load associated with the first network node, mobility information of the UE, or capability information of the UE.

Aspect 21. The first network node of any of aspects 16-20, wherein the received key generation information corresponding to the second network node is unique to the second network node and independent of other network nodes, and wherein the received key generation information comprises at least one of a cell group identifier, a network node identifier, a counter, or a random number.

Aspect 22. The first network node of any of aspects 16-21, wherein the one or more processors are further configured to cause the first network node to: associate the first network node with a first cell group; associate the second network node with a second cell group, wherein the first cell group and the second cell group are hierarchically independent from each other and are associated with a same core network; configure the first cell group as a serving cell group for the UE; and configure the second cell group as a target cell group for dual-connectivity or handover of the UE.

Aspect 23. The first network node of any of aspects 16-22, wherein the first network node and the second network node comprise a first base station and a second base station respectively, implemented in a radio access network.

Aspect 24. A method for wireless communication, the method comprising: at a first network node, establishing a first radio resource control (RRC) connection between the first network node and a user equipment (UE); at the first network node, identifying a second network node configured to serve the UE, wherein the second network node is neighboring the first network node; at the first network node, in response to identifying the second network node configured to serve the UE, receiving key generation information for the second network node; and at the first network node, transmitting a message comprising the received key generation information to the UE.

Aspect 25. The method of aspect 24, further comprising: transmitting a request to a core network requesting the key generation information for the second network node, wherein the request comprises identity information of the second network node; and receiving a response from the core network, the response comprising the key generation information for the second network node.

Aspect 26. The method of aspect 25, wherein: transmitting the request to the core network requesting the key generation information for the second network node comprises transmitting the request to the core network requesting the key generation information for the second network node and key generation information for at least one third network node neighboring the first network node; and receiving the response from the core network comprises receiving the response comprising the key generation information for the second network node and the key generation information for the at least one third network node.

Aspect 27. The method of aspect 24, wherein receiving the key generation information for the second network node comprises: receiving the key generation information from the second network node.

Aspect 28. The method of any of aspects 24-27, wherein identifying the second network node configured to serve the UE comprises: identifying the second network node based on one or more of measurement reports received from the UE, a load associated with the first network node, mobility information of the UE, or capability information of the UE.

Aspect 29. The method of any of aspects 24-28, wherein the received key generation information corresponding to the second network node is unique to the second network node and independent of other network nodes, and wherein the received key generation information comprises at least one of a cell group identifier, a network node identifier, a counter, or a random number.

Aspect 30. The method of any of aspects 24-29, further comprising: associating the first network node with a first cell group; associating the second network node with a second cell group, wherein the first cell group and the second cell group are hierarchically independent from each other and are associated with a same core network; configuring the first cell group as a serving cell group for the UE; and configuring the second cell group as a target cell group for dual-connectivity or handover of the UE.

Aspect 31. A network node for wireless communication, the network node comprising: one or more memories; and one or more processors coupled to the one or more memories and individually or collectively configured to cause the network node to: transmit a request message to a core network requesting a security key corresponding to the network node; and receive a response message from the core network, the response message including the security key corresponding to the network node.

Aspect 32. The network node of aspect 31, wherein the one or more processors are individually or collectively configured to further cause the network node to: receive, from another network node, a request for key generation information corresponding to the network node; and transmit a response to the other network node, the response comprising the key generation information corresponding to the network node.

Aspect 33. The network node of aspect 32, wherein: to transmit the request message to the core network, the one or more processors are individually or collectively configured to cause the network node to transmit the request message to the core network requesting the security key and the key generation information corresponding to the network node, upon receiving the request for the key generation information; and to receive the response message from the core network, the one or more processors are individually or collectively configured to cause the network node to receive the response message from the core network, the response including the security key and the key generation information corresponding to the network node.

Aspect 34. The network node of aspect 32 or 33, wherein the security key and the key generation information corresponding to the network node are unique to the network node and independent of other network nodes, and wherein the key generation information comprises at least one of a cell group identifier, a network node identifier, a counter, or a random number.

Aspect 35. The network node of any of aspects 31-34, wherein the one or more processors are individually or collectively further configured to cause the network node to: establish a radio resource control (RRC) connection between the network node and a user equipment (UE); and communicate data secured using the security key between the network node and the UE, upon establishing the RRC connection with the UE.

Aspect 36. A method for wireless communication, the method comprising: transmitting a request message to a core network requesting a security key corresponding to a network node; and receiving a response message from the core network, the response message including the security key corresponding to the network node.

Aspect 37. The method of aspect 36, further comprising: receiving, from another network node, a request for key generation information corresponding to the network node; and transmitting a response to the other network node, the response comprising the key generation information corresponding to the network node.

Aspect 38. The method of aspect 37, wherein: transmitting the request message to the core network comprises transmitting the request message to the core network requesting the security key and the key generation information corresponding to the network node, upon receiving the request for the key generation information; and receiving the response message from the core network comprises receiving the response message from the core network, the response including the security key and the key generation information corresponding to the network node.

Aspect 39. The method of aspect 37 or 38, wherein the security key and the key generation information corresponding to the network node are unique to the network node and independent of other network nodes, and wherein the key generation information comprises at least one of a cell group identifier, a network node identifier, a counter, or a random number.

Aspect 40. The method of any of aspects 36-39, further comprising: establishing a radio resource control (RRC) connection between the network node and a user equipment (UE); and communicating data secured using the security key between the network node and the UE, upon establishing the RRC connection with the UE.

Aspect 41. A core network node for wireless communication, the core network node comprising: one or more memories; and one or more processors coupled to the one or more memories and individually or collectively configured to cause the core network node to: receive a request message from a network node requesting a security key corresponding to the network node; generate the security key corresponding to the network node; and transmit a response message to the network node, the response message including the security key corresponding to the network node.

Aspect 42. The core network node of aspect 41, wherein the one or more processors are individually or collectively further configured to cause the core network node to: receive, from another network node, a request for key generation information corresponding to one or more network nodes, wherein the one or more network nodes comprise the network node; generate the key generation information corresponding to the one or more network nodes; and transmit, to the other network node, a response including the key generation information corresponding to the one or more network nodes.

Aspect 43. The network node of aspect 42, wherein the security key and the key generation information corresponding to the network node are unique to the network node and independent of other network nodes, and wherein the key generation information comprises at least one of a cell group identifier, a network node identifier, a counter, or a random number.

Aspect 44. The core network node of any of aspects 41-43, wherein: to receive the request message from the network node, the one or more processors are individually or collectively configured to cause the core network node to receive the request message from the network node requesting the security key and key generation information corresponding to the network node; to generate the security key corresponding to the network node, the one or more processors are individually or collectively configured to cause the core network node to generate the security key and the key generation information corresponding to the network node; and to transmit the response message to the network node, the one or more processors are individually or collectively configured to cause the core network node to transmit the response message to the network node, the response message including the security key and the key generation information corresponding to the network node.

Aspect 45. A method for wireless communication, the method comprising: receiving a request message from a network node requesting a security key corresponding to the network node; generating the security key corresponding to the network node; and transmitting a response message to the network node, the response message including the security key corresponding to the network node.

Aspect 46. The method of aspect 45, further comprising: receiving, from another network node, a request for key generation information corresponding to one or more network nodes, wherein the one or more network nodes comprise the network node; generating the key generation information corresponding to the one or more network nodes; and transmitting, to the other network node, a response including the key generation information corresponding to the one or more network nodes.

Aspect 47. The method of aspect 46, wherein the security key and the key generation information corresponding to the network node are unique to the network node and independent of other network nodes, and wherein the key generation information comprises at least one of a cell group identifier, a network node identifier, a counter, or a random number.

Aspect 48. The method of any of aspects 45-47, wherein: receiving the request message from the network node comprises receiving the request message from the network node requesting the security key and key generation information corresponding to the network node; generating the security key corresponding to the network node comprises generating the security key and the key generation information corresponding to the network node; and transmitting the response message to the network node comprises transmitting the response message to the network node, the response message including the security key and the key generation information corresponding to the network node.

Aspect 49. A user equipment (UE) for wireless communication, the UE comprising one or more means for performing operations according to any of aspects 9 to 15.

Aspect 50. A first network node for wireless communication, the first network node comprising one or more means for performing operations according to any of aspects 24 to 30.

Aspect 51. A network node for wireless communication, the network node comprising one or more means for performing operations according to any of aspects 36 to 40.

Aspect 52. A core network node for wireless communication, the core network node comprising one or more means for performing operations according to any of aspects 45 to 48.

Aspect 53. A non-transitory computer-readable medium comprising instructions stored thereon which, when executed by one or more processors, cause a user equipment (UE) to perform operations according to any of aspects 9-15.

Aspect 54. A non-transitory computer-readable medium comprising instructions stored thereon which, when executed by one or more processors, cause a first network node to perform operations according to any of aspects 24 to 30.

Aspect 55. A non-transitory computer-readable medium comprising instructions stored thereon which, when executed by one or more processors, cause a network node to perform operations according to any of aspects 36 to 40.

Aspect 56. A non-transitory computer-readable medium comprising instructions stored thereon which, when executed by one or more processors, cause a core network node to perform operations according to any of aspects 45 to 48.

Although aspects of an LTE, LTE-A, LTE-A Pro, NR, 4G, 5G, 6G system may be described for purposes of example, and LTE, LTE-A, LTE-A Pro, NR, 4G, 5G, 6G terminology may be used in much of the description, the techniques described herein are applicable beyond LTE, LTE-A, LTE-A Pro, NR, 4G, 5G, 6G networks.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC. Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Also, as used herein, the phrase “a set” shall be construed as including the possibility of a set with one member. That is, the phrase “a set” shall be construed in the same manner as “one or more.”

The term “determine” or “determining” encompasses a variety of actions and, therefore, “determining” can include calculating, computing, processing, deriving, generating, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, the UE comprising:
one or more memories; and
one or more processors coupled to the one or more memories and individually or collectively configured to cause the UE to:
establish a first radio resource control (RRC) connection between the UE and a first network node;
receive, from the first network node, a message comprising key generation information configured to generate a security key corresponding to a second network node neighboring the first network node; and
generate the security key corresponding to the second network node based at least in part on the key generation information and an anchor key shared between the UE and a core network.

2. The UE of claim 1, wherein the one or more processors are individually or collectively further configured to cause the UE to:
establish, while maintaining the first RRC connection, a second RRC connection with the second network node; and
communicate data secured using the security key between the UE and the second network node, upon establishing the second RRC connection with the second network node.

3. The UE of claim 1, wherein the anchor key is unique to the UE, and wherein the key generation information comprises at least one of a cell group identifier, a network node identifier, a counter, or a random number.

4. The UE of claim 1, wherein the security key and the key generation information corresponding to the second network node are unique to the second network node and independent of other network nodes.

5. The UE of claim 1, wherein the first network node is associated with a first cell group and the second network node is associated with a second cell group, wherein the first cell group and the second cell group are hierarchically independent from each other and are associated with the core network, and wherein the first cell group is configured as a serving cell group for the UE and the second cell group is configured as a target cell group for dual-connectivity or handover of the UE.

6. The UE of claim 1, wherein the first network node and the second network node comprise a first base station and a second base station respectively, implemented in a radio access network.

7. The UE of claim 1, wherein the message further comprises key generation information configured to generate at least one security key corresponding to at least one third network node neighboring the first network node, the at least one security key corresponding to the at least one third network node being configured to secure data communicated between the UE and the at least one third network node.

8. A method for wireless communication, the method comprising:
at a user equipment (UE), establishing a first radio resource control (RRC) connection between the UE and a first network node;
at the UE, receiving, from the first network node, a message comprising key generation information configured to generate a security key corresponding to a second network node neighboring the first network node; and
at the UE, generating the security key corresponding to the second network node based at least in part on the key generation information and an anchor key shared between the UE and a core network.

9. The method of claim 8, further comprising:
establishing, while maintaining the first RRC connection, a second RRC connection with the second network node; and
communicating data secured using the security key between the UE and the second network node, upon establishing the second RRC connection with the second network node.

10. The method of claim 8, wherein the anchor key is unique to the UE, and wherein the key generation information comprises at least one of a cell group identifier, a network node identifier, a counter, or a random number.

11. The method of claim 8, wherein the security key and the key generation information corresponding to the second network node are unique to the second network node and independent of other network nodes.

12. The method of claim 8, wherein the first network node is associated with a first cell group and the second network node is associated with a second cell group, wherein the first cell group and the second cell group are hierarchically independent from each other and are associated with the core network, and wherein the first cell group is configured as a serving cell group for the UE and the second cell group is configured as a target cell group for dual-connectivity or handover of the UE.

13. The method of claim 8, wherein the message further comprises key generation information configured to generate at least one security key corresponding to at least one third network node neighboring the first network node, the at least one security key corresponding to the at least one third network node being configured to secure data communicated between the UE and the at least one third network node.

14. A first network node for wireless communication, the first network node comprising:
one or more memories; and
one or more processors coupled to the one or more memories and individually or collectively configured to cause the first network node to:
establish a first radio resource control (RRC) connection between the first network node and a user equipment (UE);
identify a second network node configured to serve the UE, wherein the second network node is neighboring the first network node;
in response to identifying the second network node configured to serve the UE, receive key generation information for the second network node; and
transmit a message comprising the received key generation information to the UE.

15. The first network node of claim 14, wherein the one or more processors are individually or collectively further configured to cause the first network node to:
transmit a request to a core network requesting the key generation information for the second network node, wherein the request comprises identity information of the second network node; and
receive a response from the core network, the response comprising the key generation information for the second network node.

16. The first network node of claim 15, wherein:
to transmit the request to the core network requesting the key generation information for the second network node, the one or more processors are individually or collectively configured to cause the first network node to transmit the request to the core network requesting the key generation information for the second network node and key generation information for at least one third network node neighboring the first network node; and
to receive the response from the core network, the one or more processors are individually or collectively configured to cause the first network node to receive the response comprising the key generation information for the second network node and the key generation information for the at least one third network node.

17. The first network node of claim 14, wherein to receive the key generation information for the second network node, the one or more processors are individually or collectively configured to cause the first network node to:
receive the key generation information from the second network node.

18. The first network node of claim 14, wherein to identify the second network node configured to serve the UE, the one or more processors are individually or collectively configured to cause the first network node to:
identify the second network node based on one or more of measurement reports received from the UE, a load associated with the first network node, mobility information of the UE, or capability information of the UE.

19. The first network node of claim 14, wherein the received key generation information corresponding to the second network node is unique to the second network node and independent of other network nodes, and wherein the received key generation information comprises at least one of a cell group identifier, a network node identifier, a counter, or a random number.

20. The first network node of claim 14, wherein the one or more processors are individually or collectively further configured to cause the first network node to:
associate the first network node with a first cell group;
associate the second network node with a second cell group, wherein the first cell group and the second cell group are hierarchically independent from each other and are associated with a same core network;
configure the first cell group as a serving cell group for the UE; and
configure the second cell group as a target cell group for dual-connectivity or handover of the UE.
